(19) United States
(12) Patent Application Publication
(10) Pub. No.: US 2025/0341705 A1
(43) Pub. Date: Nov. 6, 2025

(54) OPTICAL SYSTEM AND CAMERA MODULE COMPRISING SAME

(71) Applicant: LG INNOTEK CO., LTD., Seoul (KR)

(72) Inventor: Duk Keun KWON, Seoul (KR)

(73) Assignee: LG INNOTEK CO., LTD., Seoul (KR)

(21) Appl. No.: 18/867,076

(22) PCT Filed: May 22, 2023
(86) PCT No.: PCT/KR2023/006944

§ 371 Date: Nov. 19, 2024

(30) Foreign Application Priority Data
May 20, 2022 (KR) 10-2022-0062223

(51) Int. Cl. G02B 13/00

(52) U.S. Cl. CPC G02B 13/0045

(57) ABSTRACT

The optical system disclosed in the embodiment of the invention includes first to eighth lenses aligned along an optical axis from an object side toward a sensor side, wherein an object-side surface of the first lens is convex, at least one of an object-side and sensor-side surfaces of the seventh lens has at least one critical point, and at least one of the object-side and sensor-side surfaces of the eighth lens has a freeform surface shape in which a lens surface orthogonal to the optical axis in a first direction and a lens surface orthogonal to the optical axis in a second direction are asymmetrical, and the freeform surface may have both lens surfaces having a symmetrical shape in the first direction with respect to the optical axis, and both lens surfaces having a symmetrical shape in the first direction in the second direction with respect to the optical axis.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, distance, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system. Therefore, a new optical system capable of solving the above problems is required.

### DISCLOSURE

### Technical Problem

An embodiment of the invention provides an optical system with improved optical properties. The embodiment provides an optical system having excellent optical performance at the center and periphery portions of the field of view. The embodiment provides an optical system capable of having a slim structure.

### Technical Solution

An optical system according to an embodiment of the invention comprises first to eighth lenses aligned along an optical axis from an object side toward a sensor side, wherein an object-side surface of the first lens is convex, at least one of an object-side and sensor-side surfaces of the seventh lens has at least one critical point, and at least one of the object-side and sensor-side surfaces of the eighth lens has a freeform surface shape in which a lens surface orthogonal to the optical axis in a first direction and a lens surface orthogonal to the optical axis in a second direction are asymmetrical, and the freeform surface may have both lens surfaces having a symmetrical shape in the first direction with respect to the optical axis, and both lens surfaces having a symmetrical shape in the first direction in the second direction with respect to the optical axis.

According to an embodiment of the invention, each of the object-side surface and the sensor-side surface of the seventh lens has the critical point, and the critical point of the sensor-side surface of the seventh lens may be disposed further outside than the critical point of the object-side surface of the seventh lens with respect to the optical axis.

According to an embodiment of the invention, the object-side surface of the eighth lens may be provided without a critical point from the optical axis to the end of the effective region. The sensor-side surface of the eighth lens may have a critical point, and the critical point of the sensor-side surface of the eighth lens may be located closer to the optical axis than the critical point of the seventh lens. The critical point of the sensor-side surface of the eighth lens may be located at different distances from each other along the first direction and the second direction orthogonal to each other with respect to the optical axis.

According to an embodiment of the invention, at least one of the seventh lens and the eighth lens includes regions having different thicknesses at the same distance along the first and second directions orthogonal to each other with respect to the optical axis.

According to an embodiment of the invention, a distance between the sixth lens and the seventh lens may include regions having different distances at the same distance along the first direction and the second direction orthogonal to each other with respect to the optical axis. A distance between the seventh lens and the eighth lens may include regions having different distances at the same distance along the first direction and the second direction orthogonal to each other with respect to the optical axis.

According to an embodiment of the invention, a maximum angle between the optical axis and a normal line perpendicular to a tangent passing through the sensor-side surface of the seventh lens or the eighth lens may include regions having different angles at the same distance along the second direction and the first direction orthogonal with respect to the optical axis.

According to an embodiment of the invention, the first lens has a positive refractive power and has a meniscus shape convex toward the object side on the optical axis, and the second and third lenses may have opposite refractive powers to each other and include a meniscus shape convex toward the object side on the optical axis.

According to an embodiment of the invention, the fourth and fifth lenses may have refractive powers opposite to each other, and the seventh and eighth lenses may have refractive powers opposite to each other. The seventh and eighth lenses have a convex meniscus shape toward the sensor side.

An optical system according to an embodiment of the invention includes a first lens portion disposed along an optical axis from an object side to a sensor side and having a plurality of lenses having rotationally symmetrical aspherical surfaces, and a second lens portion disposed on the sensor side of the first lens portion and including a plurality of lenses having non-rotationally symmetrical curved surfaces, wherein each lens of the second lens portion may have a thickness that is non-rotationally symmetrical thickness along first and second directions orthogonal to the optical axis, and a distance between the lenses of the second lens portion may have non-rotationally symmetrical along first and second directions orthogonal to the optical axis.

According to an embodiment of the invention, an effective focal length of the optical system in the first direction is Fx, an effective focal length in the second direction is Fy, and the following Equation may satisfy: 0≤|Fx−Fy|≤0.1.

According to an embodiment of the invention, the lenses of the second lens portion may have different effective focal lengths in the first direction and in the second direction.

According to an embodiment of the invention, at least three of the lenses of the first lens portion disposed close to an object may have a meniscus shape convex toward the object side, and the lenses of the second lens portion may have a meniscus shape convex toward the sensor side.

According to an embodiment of the invention, an object-side surface and a sensor-side surface of each of the lenses of the second lens portion may have a freeform surface.

According to an embodiment of the invention, a distance from a center of an object-side surface of the first lens portion to an image surface of the image sensor is TTL, ½ of a diagonal length of the image sensor is ImgH, a total number of lenses is n, and the following Equation may satisfy: 5< (TTL/ImgH)*n<15.

According to an embodiment of the invention, the effective focal length of the optical system is F, ½ of the diagonal length of the image sensor is ImgH, the total number of lenses is n, and the following Equation may satisfy: 4< (F/ImgH)*n<14.

An optical system according to an embodiment of the invention includes a first lens group having lenses having a meniscus shape convex toward an object side; and a second lens group arranged on a sensor side of the first lens group, wherein the second lens group has more lenses than a number of lenses in the first lens group, the first lens group has a positive (+) refractive power on the optical axis, the second lens group has a negative (−) refractive power on the optical axis, the number of lenses in the second lens group is less than twice the number of lenses in the first lens group, one of the lenses adjacent between the first and second lens groups has the smallest effective diameter, an n-th lens closest to the image sensor among the lenses of the second lens group has the largest effective diameter, and the n-th lens and an n−1th lens of the second lens group may have a non-rotationally symmetric curved surface.

According to an embodiment of the invention, a sensor-side surface of the n-th lens, an object-side surface and a sensor-side surface of the n−1th lens have a critical point, and the non-rotationally symmetric curved surface has both lens surfaces having a symmetrical shape in a first direction orthogonal to the optical axis and has both lens surfaces having a symmetrical shape in a second direction orthogonal to the optical axis, and the lens surfaces in the first and second directions may have asymmetrical shape to each other.

According to an embodiment of the invention, the n-th lens and the n−1th lens may include regions having different thicknesses at the same distance from the optical axis along the first and second directions orthogonal to the optical axis.

A camera module according to an embodiment of the invention includes an image sensor; a filter between the image sensor and a last lens of an optical system; and the optical system disclosed above, wherein a distance from a center of a lens surface closest to an object to an image surface of the image sensor is TTL, ½ of the diagonal length of the image sensor is ImgH, and a maximum thickness at a center of each lens is CT_Max, a maximum of distances between adjacent lenses is CG_Max, a total number of lenses is n, and it may satisfy Equation 1:5< (TTL/ImgH)*n<15 and Equation 2:10< (CT_Max+CG_Max)*n<20.

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the FOV.

The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment(s) of the invention.

FIG. 2 is an explanatory diagram illustrating a relationship between an image sensor, an n-th lens, and an n−1th lens of the optical system of FIG. 1.

FIG. 3 is a table showing lens data according to the first embodiment having the optical system of FIG. 1.

FIG. 4a is an example of aspherical surface coefficients of the first to sixth lenses according to the first embodiment of the invention.

FIG. 4b is an example of free spherical surface coefficients of the seventh to eighth lenses according to the first embodiment of the invention.

FIG. 5a is a table showing thicknesses of first to sixth lenses and distances between the first to sixth lenses along a first direction in the optical system according to the first embodiment of the invention.

FIG. 5b is a table showing a distance between fifth and sixth lenses and a thickness of a seventh lens along a first direction in the optical system according to the first embodiment of the invention.

FIG. 5c is a table showing a distance between seventh and eighth lenses and a thickness of an eighth lens along a first direction in the optical system according to a first embodiment of the invention.

FIGS. 6a and 6b are tables showing Sag (sagittal) height data of the n-th lens and the n−1th lens in the optical system according to the first embodiment of the invention.

FIGS. 7a and 7b are tables showing angles with respect to tangents passing through the surfaces of the n-th lens and the n−1th lens in the optical system according to the first embodiment of the invention.

FIG. 8 is a table showing lens data according to a second embodiment having an optical system of FIG. 1.

FIG. 9a is an example of aspherical surface coefficients of the first to sixth lenses according to the second embodiment of the invention.

FIG. 9b is an example of free spherical surface coefficients of the seventh to eighth lenses according to the second embodiment of the invention.

FIG. 10a is a table showing thicknesses of first to sixth lenses and distances between the first to sixth lenses along a first direction in an optical system according to a second embodiment of the invention.

FIG. 10b is a table showing the distance between the fifth and sixth lenses and the thickness of the seventh lens in the first direction in the optical system according to the second embodiment of the invention.

FIG. 10c is a table showing the distance between the seventh and eighth lenses and the thickness of the eighth lens in the first direction in the optical system according to the second embodiment of the invention.

FIGS. 11a and 11b are tables showing Sag (sagittal) height data of the n-th lens and the n−1th lens in the optical system according to the second embodiment of the invention.

FIGS. 12a and 12b are tables showing angles with respect to tangents passing through the surfaces of the n-th lens and the n−1th lens in the optical system according to the second embodiment of the invention.

FIG. 13 is a graph showing Sag (sagittal) data according to heights and angular positions (0 degree, 30 degree, 45 degree, 60 degree, 90 degree) of the object-side surface and the sensor-side surface of the seventh lens in the optical system according to the first and second embodiments.

FIG. 14 is a graph showing Sag (sagittal) data according to heights and angular positions (0 degree, 30 degree, 45 degree, 60 degree, 90 degree) of the object-side surface and the sensor-side surface of the eighth lens in the optical system according to the first and second embodiments.

FIG. 15 is a graph showing curves connecting ends of effective regions of respective lenses based on an optical axis in the optical system according to the first and second embodiments as a two-dimensional function.

FIG. 16 is a graph showing lines connecting the ends of effective regions of the object-side surface and the sensor-side surface from the fourth lens to the eighth lens based on the optical axis in the optical system according to the first and second embodiments as a one-dimensional function.

FIG. 17 is a diagram showing that an optical system or a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to +0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region. The refractive index of each lens may be based at a d-line (587.56 nm) wavelength.

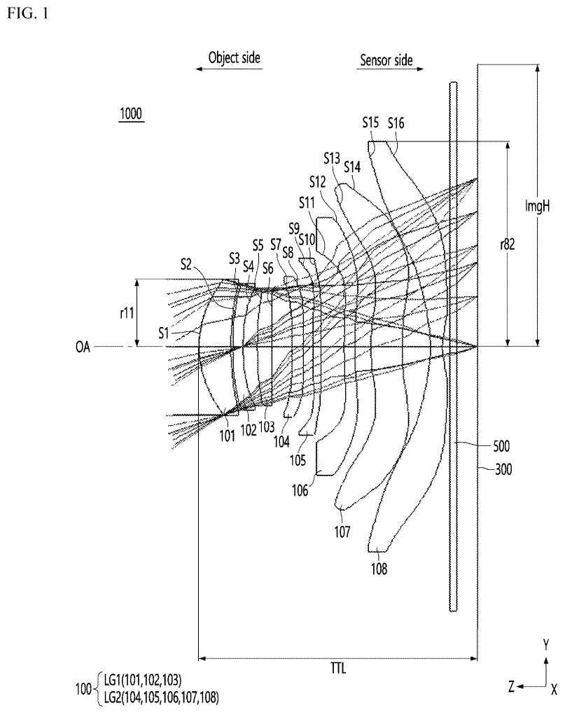

FIG. 1 is a diagram showing an optical system 1000 and a camera module having the same according to embodiment of the invention.

Referring to FIGS. 1, 2, 3 and 8, the optical system 1000 or the camera module may include a lens portion 100 having a plurality of lenses. The lens portion 100 may include 5 or more or 10 or less lenses. The optical system 1000 may include a plurality of lens groups LG1 and LG2. In detail, each of the plurality of lens groups LG1 and LG2 includes at least one lens. For example, the optical system 1000 may include a first lens group LG1 and a second lens group LG2 sequentially disposed along the optical axis OA toward the image sensor 300 from the object side.

The first lens group LG1 guides the path of incident light in the optical axis direction, and the second lens group LG2 guides the path of light emitted through the first lens group LG1 from the center portion to the periphery portion of the image sensor 300.

The number of lenses of the second lens group LG2 may be greater than the number of lenses of the first lens group LG1, for example, 1.1 times or more and 2 times or less of the number of lenses of the first lens group LG1. The first lens group LG1 may include two or more lenses or four or less lenses. The first lens group LG1 may be, for example, three lenses. The second lens group LG2 may include four or more lenses. The second lens group LG2 may include more lenses than the number of lenses of the first lens group LG1, for example, six or less. The number of lenses of the second lens group LG2 may be four or more greater than the number of lenses of the first lens group LG1, and may include, for example, five lenses. The optical system 1000 may include ten or less lenses or nine lenses or less.

In the optical system 1000, the total track length (TTL) may be less than 70% of the diagonal length of the image sensor 300, and may be, for example, in the range of 40% to 69% or 45% to 55%. The TTL is a distance in the optical axis OA from the object-side surface of the lens closest to an object to the surface of the image sensor 300, and the diagonal length of the image sensor 300 is the maximum diagonal length of the image sensor 300, and may be twice the distance (ImgH) from the optical axis OA to the diagonal end. Accordingly, when the following condition: TTL/(ImgH*2) satisfies the above range, a slim optical system and a camera module having the same may be provided. The total number of lenses of the first and second lens groups LG1 and LG2 is 7 to 9.

The lenses of the lens portion 100 may be formed of plastic lenses or glass lenses. The lenses of the lens portion 100 may be a mixture of plastic lenses and glass lenses. The lenses of the lens portion 100 may include lenses having an aspherical surface and lenses having a freeform surface. In the aspherical surface, the object-side surface or/and the sensor-side surface of each lens is a rotationally symmetrical aspherical surface, and the freeform surface may have a non-rotationally symmetrical curved surface or a rotationally asymmetrical aspheric surface on the object-side surface or/and sensor-side surface of each lens. Since the lens portion 100 includes lenses having a rotationally symmetric aspherical surface and a rotationally asymmetric aspheric surface, light distribution to the periphery portion of the image sensor 300 may be improved.

The lens having the freeform surface has a non-rotationally symmetric curved surface in a first direction X and a second direction Y orthogonal to each other with respect to the optical axis OA. The lens having the freeform surface may have a non-rotationally symmetric curved surface in an axial direction (a direction perpendicular to the optical axis) between the first direction X and the second direction Y.

The first lens group LG1 may include lenses having an aspherical surface, and the second lens group LG2 may include one or more lenses having freeform surfaces, for example, two or more lenses. The lens having the freeform surface may include an n-th lens and an n−1th lens. The n is the total number of lenses. Accordingly, since the n-th and n−1th lenses adjacent to the image sensor 300 are provided as freeform surfaces, light may be refracted uniformly over the entire region of the image sensor 300.

The first lens group LG1 may have positive (+) refractive power. The second lens group LG2 may have a different negative (−) refractive power than the first lens group LG1. The first lens group LG1 and the second lens group LG2 have different focal lengths and different refractive powers, and thus have good optical performance at the center and periphery portion of the FOV. The refractive power is the reciprocal of the focal length. FLG1 is the focal length of the first lens group, FLG2 is the focal length of the second lens group, and the following condition may satisfy: FLG1>|FLG2|. Also, the following condition may satisfy: 1.1<FLG1/|FLG2|<5. Here, the following condition may satisfy: FLG1*FLG2<0. Accordingly, the optical system 1000 according to the embodiment may have improved aberration control characteristics such as chromatic aberration and distortion aberration by controlling the refractive power and focal length of each lens group, and good optical performance in the center and periphery portions of the FOV (filed of view).

Here, when the focal length of the second lens group LG2 is the average of the focal lengths in the first and second directions X and Y, the focal length of the second lens group LG2 in the first direction X is FxLG2, and the focal length in the second direction Y is FyLG2, the following condition may satisfy: FxLG2/FyLG2, and the following condition may satisfy: 0<|FxLG2−FxLG2|<0.7. Accordingly, it is possible to have good optical performance in the center and periphery portions of the FOV.

In addition, since the lens surfaces of the seventh and eighth lenses 107 and 108 have freeform surfaces, the focal length Fx7 in the first direction and the focal length Fy7 in the second direction of the seventh lens 107 are different from each other. The focal length Fx8 in the first direction and the focal length Fy8 in the second direction of the eighth lens 108 may be different from each other. Due to such a freeform surface, decrease in the amount of light in the periphery region of the image sensor 300 may be prevented.

In the first lens group LG1, lenses having a meniscus shape convex toward the object side may be stacked. The second lens group LG2 may have a meniscus shape in which a first of the lenses on the object side is convex toward the sensor side. The first lens group LG1 refracts the light incident through the object side to converge, and the second lens group LG2 may refracted light emitted through the first lens group LG1 so that it may be diffused to the periphery portion of the image sensor 300. Accordingly, the two lens surfaces facing each other in the first and second lens groups LG1 and LG2, for example, the sensor-side surface of the first lens group LG1 is concave on the optical axis, and the object-side surface of the second lens group LG2 is concave on the optical axis. In addition, the two lenses facing each other in the first and second lens groups LG1 and LG2 may have refractive powers opposite to each other.

In the optical axis OA, the first lens group LG1 and the second lens group LG2 may have a set distance. The optical axis distance between the first lens group LG1 and the second lens group LG2 in the optical axis OA is the separation distance in the optical axis OA, and may be an optical axis distance between the sensor-side surface of the lens closest to the sensor side among the lenses in the first lens group G1 and the object-side surface of the lens closest to the object side among the lenses in the second lens group G2. The optical axis distance between the first lens group LG1 and the second lens group LG2 is greater than the center thickness of the last lens of the lenses in the first lens group LG1 and greater than a center thickness the first of lenses in the second lens group LG2. The optical axis distance between the first lens group LG1 and the second lens group LG2 may be 35% or less of the optical axis distance of the first lens group LG1, for example in a range of 20% to 35% of the optical axis distance of the optical axis distance of the first lens group LG1. Here, the optical axis distance of the first lens group G1 is a distance along the optical axis between the object-side surface of the lens closest to the object side of the first lens group G1 and the sensor-side surface of the lens closest to the sensor side.

The optical axis distance between the first lens group LG1 and the second lens group LG2 may be 18% or less of the optical axis distance of the second lens group LG2, for example, in a range of 5% to 18% or 10% to 15%. The optical axis distance of the second lens group G2 is a distance along the optical axis between the object-side surface of the lens closest to the object side of the second lens group G2 and the sensor-side surface of the lens closest to the sensor side.

An effective diameter of the lenses of the first lens group LG1 may gradually decrease from the object side toward the sensor side. An effective diameter of the lenses of the first lens group LG1 may gradually decrease from the object side toward the sensor side. The effective diameter of each lens of the lens portion 100 may gradually decrease from the object side to the lens surface where the aperture stop is located, and may gradually increase from the aperture stop to the image sensor 300.

A lens having the smallest effective diameter in the first lens group LG1 may be a lens closest to the second lens group LG2. A lens having the smallest effective diameter in the second lens group LG2 may be a lens closest to the first lens group LG1. Here, the size of the effective diameter is an average value of the effective diameter of the object-side surface and the effective diameter of the sensor-side surface of each lens. Accordingly, the optical system 1000 may have good optical performance not only at the center portion of the FOV but also at the periphery portion, and chromatic aberration and distortion aberration may be improved. A size of a lens having a minimum effective diameter in the first lens group LG1 may be smaller than a size of a lens having a minimum effective diameter in the second lens group LG2.

A difference between the effective diameters of the lenses having the smallest effective diameters in the first lens group LG1 and the second lens group LG2 may be 0.2 mm or less. Accordingly, light loss in the region between the first and second lens groups LG1 and LG2 may be reduced.

The lens closest to the object side among the lenses of the first lens group LG1 has negative (+) refractive power, and the lens closest to the sensor side among the lenses of the second lens group G2 may have negative (−) refractive power. In the optical system 1000, the number of lenses having positive (+) refractive power may be the same as or different from the number of lenses having negative (−) refractive power. In the second lens group LG2, the number of lenses having positive (+) refractive power may be smaller than the number of lenses having negative (−) refractive power.

Each of the plurality of lenses 100 may include an effective region and a non-effective region. The effective region may be a region through which light incident to each of the lenses 100 passes. That is, the effective region may be an effective region in which the incident light is refracted to realize optical characteristics. The non-effective region may be arranged around the effective region. The non-effective region may be an area in which effective light from the plurality of lenses 100 is not incident. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS). The diagonal length of the image sensor 300 may be greater than 8 mm, for example, greater than 8 mm and less than 30 mm, and may be defined as twice ImgH. Preferably, the image sensor 300 may satisfy the condition: ImgH<TTL<(2*ImgH).

The optical system 1000 may include an optical filter 500. The optical filter 500 may be disposed between the second lens group LG2 and the image sensor 300. The optical filter 500 may be disposed between a lens closest to a sensor side among the plurality of lenses 100 and the image sensor 300. For example, when the optical system 100 has 8 lenses, the optical filter 500 may be disposed between the eighth lens 108 and the image sensor 300.

The optical filter 500 may include an infrared filter. The optical filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 may transmit visible light and reflect infrared light. As another example, a cover glass may be further disposed between the optical filter 500 and the image sensor 300.

The optical system 1000 according to the embodiment may include an aperture stop ST. The aperture stop ST may be a stopper for adjusting the amount of light incident on the optical system 1000. The aperture stop ST may be disposed around at least one lens of the first lens group LG1. For example, the aperture stop ST may be disposed around an object-side surface or a sensor-side surface of the second lens 102. The aperture stop ST may be disposed between two adjacent lenses 101 and 102 among the lenses in the first lens group LG1. Alternatively, at least one lens selected from among the plurality of lenses 100 may serve as an aperture stop. In detail, an object-side surface or a sensor-side surface of one lens selected from among the lenses of the first lens group LG1 may serve as an aperture stop for adjusting the amount of light.

The optical axis distance from the aperture stop ST to the sensor-side surface of the n-th lens is SD, the optical-axis distance from the object-side surface of the first lens 101 to the sensor-side surface of the n-th lens is TD, and it may satisfy: SD<TD. In addition, the following condition may satisfy: SD<ImgH. In addition, the following condition may satisfy: SD<TTL.

EFL is the effective focal length of the entire optical system and may be defined as F. The following condition may satisfy: F<ImgH, the difference between F and ImgH may be 0.5 mm or less, and F is in the range of 6 mm to 10 mm. The field of view (FOV) of the optical system 1000 may be less than 120 degrees, for example, more than 70 degrees and less than 100 degrees. The F number (F #) of the optical system 1000 may satisfy a condition of greater than 1 and less than 10, for example, in a range of 1.1≤F #≤5. In addition, the entrance pupil diameter is EPD, and the following condition may satisfy: F #<EPD. Also, the following condition may satisfy: (TTL-ImgH)<EPD. Accordingly, the optical system 1000 has a slim size, may control incident light, and may have improved optical characteristics within a FOV.

The optical system 1000 according to the embodiment may further include a reflective member (not shown) for changing a path of light. The reflective member may be implemented as a prism that reflects incident light of the first lens group LG1 toward the lenses. Hereinafter, an optical system according to an embodiment will be described in detail.

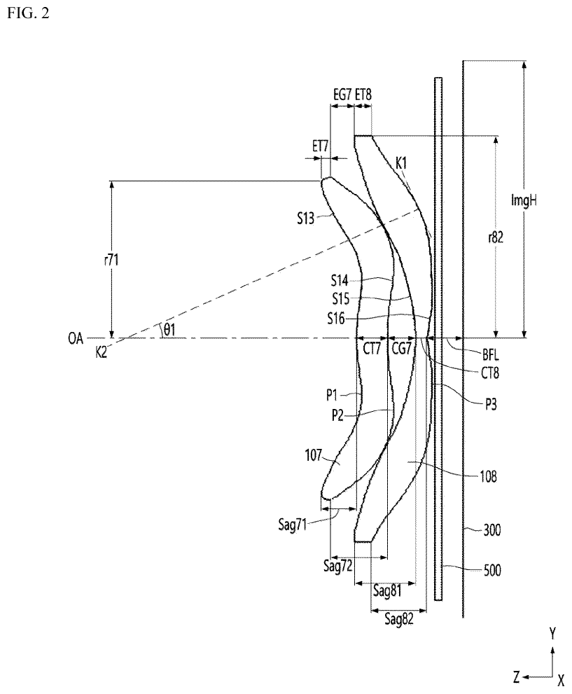

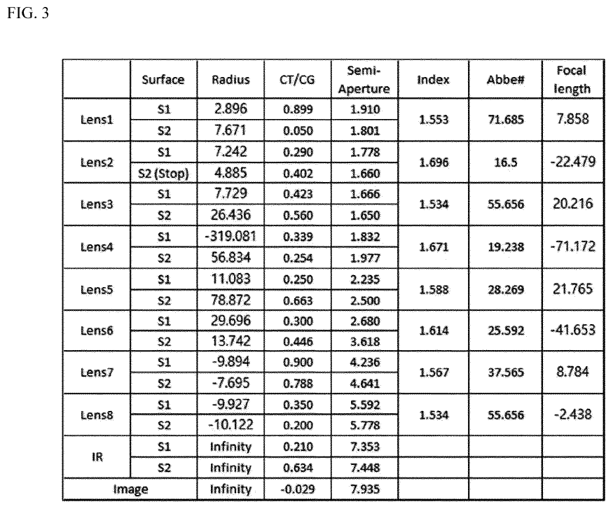

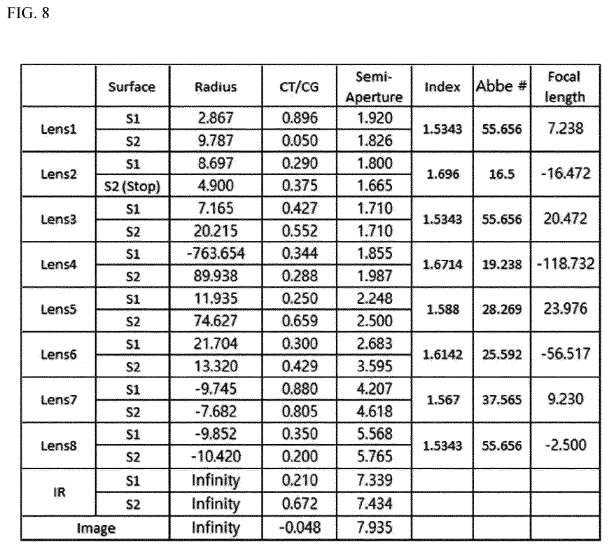

FIG. 1 is a configuration diagram of an optical system and a camera module according to an embodiment of the invention, FIG. 2 is an explanatory view showing the relationship between an image sensor, an n-th lens, and an n−1th lens of the optical system of FIG. 1, and FIG. 3 is a table showing lens data according to the first embodiment having an optical system, and FIG. 8 is a table showing lens data according to a second embodiment having an optical system in FIG. 1.

Referring to FIGS. 1, 2, 3, and 8, an optical system 1000 according to an embodiment may include a first lens 101 to an eighth lens 108. The first to eighth lenses 101 to 108 may be sequentially aligned along the optical axis OA of the optical system 1000. Light corresponding to object information may pass through the first lens 101 to the eighth lens 108 and the optical filter 500 and be incident on the image sensor 300.

The first lens group LG1 may include the first to third lenses 101, 102, and 103, and the second lens group LG2 may include the fourth to eighth lenses 104 to 108. The distance between the third lens 103 and the fourth lens 104 may be the optical axis distance between the first and second lens groups LG1 and LG2.

Among the first to eighth lenses 101 to 108, the number of lenses having a meniscus shape convex toward the object side on the optical axis may be 4 or more, and may satisfy, for example, n−3 of the total number of lenses. The n is the total number of lenses, and may be, for example, 8.

The first lens 101 may have negative (−) or positive (+) refractive power on the optical axis OA, and may preferably have positive (+) refractive power. The first lens 101 may include a plastic or glass material. For example, the first lens 101 may be made of a plastic material.

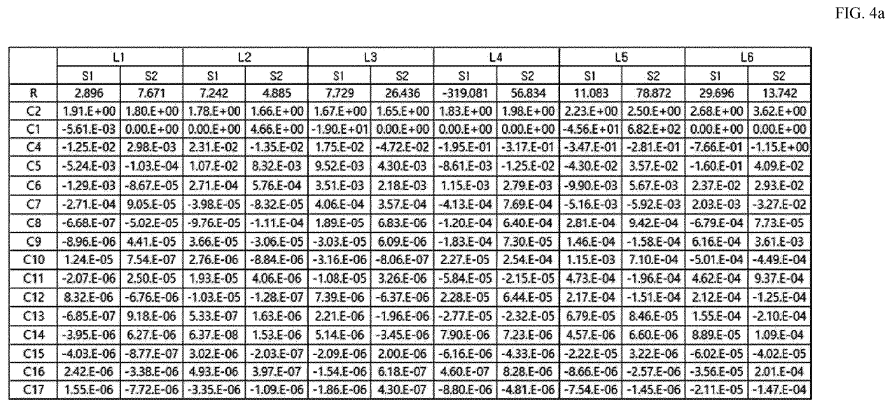

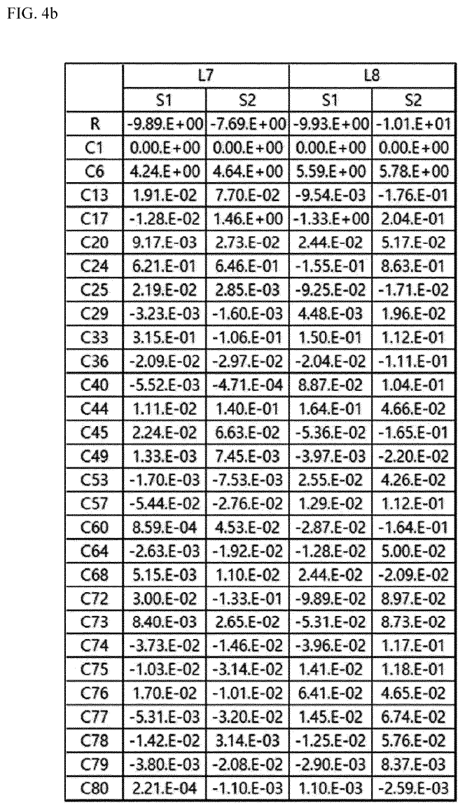

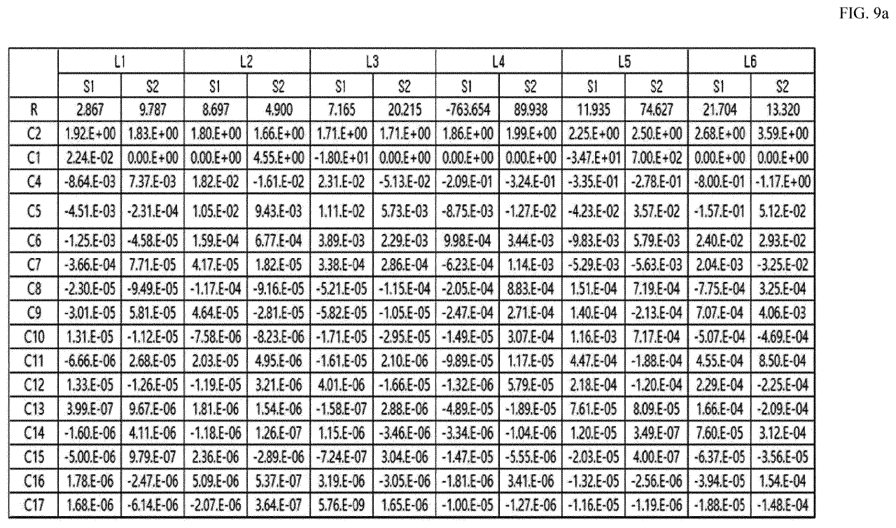

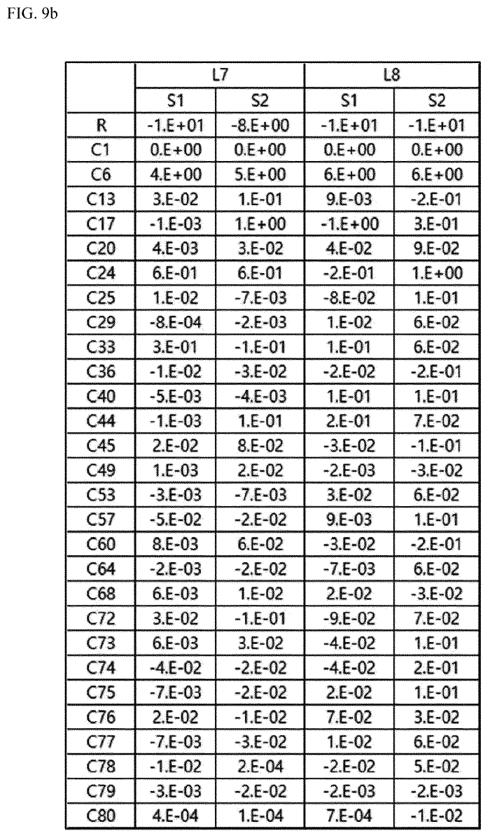

The first lens 101 may include a first surface S1 that is a convex object side and a second surface S2 that is a concave sensor side. That is, the first lens 101 may have a meniscus shape convex toward the object side on the optical axis OA. At least one or both of the first surface S1 and the second surface S2 may be aspheric. Aspheric coefficients of the first and second surfaces S1 and S2 are provided as shown in FIGS. 4a and 9a, L1 is the first lens 101, L1S1 is the first surface, and L1S2 is the second surface.

The Abbe number of the first lens 101 is ν1, ν1 is greater than 60, the refractive index of the first lens 101 is n1, and ν1 may satisfy: (n1*40)<ν1<(n1*55). Accordingly, the first lens 101 may refract incident light to minimize chromatic dispersion.

The second lens 102 may have positive (+) or negative (−) refractive power on the optical axis OA. The second lens 102 may have negative (−) refractive power. The second lens 102 may include a plastic or glass material. For example, the second lens 102 may be made of a plastic material.

The second lens 102 may include a third surface S3 that is an object side and a fourth surface S4 that is a sensor side, and the third surface S3 may be convex on the optical axis OA, The fourth surface S4 may have a concave shape. That is, the second lens 102 may have a meniscus shape convex toward the object side on the optical axis OA. Alternatively, on the optical axis OA, the third surface S3 may have a convex shape, and the fourth surface S4 may have a convex shape. At least one or both of the third surface S3 and the fourth surface S4 may be aspheric. Aspherical coefficients of the third and fourth surfaces S3 and S4 are provided as shown in FIGS. 4a and 9a, L2 is the second lens 102, L2S1 is the third surface, and L2S2 is the fourth surface.

The refractive index of the second lens 102 is n2, and n2 may be greater than 1.60. The Abbe number of the second lens 102 is ν2, and ν2 may be the smallest among the lenses, or may satisfy the following condition: (8*n2)<ν2<(n2*20). By providing the second lens 102 with a high refractive index within the lens portion 100, incident light may be refracted so that chromatic dispersion is increased.

The third lens 103 may have positive (+) or negative (−) refractive power on the optical axis OA, and may preferably have positive (+) refractive power. The third lens 103 may include a plastic or glass material. For example, the third lens 103 may be made of a plastic material.

The third lens 103 may include a fifth surface S5 that is an object-side surface and a sixth surface S6 that is a sensor-side surface. The fifth surface S5 may have a convex shape, and the sixth surface S6 may have a concave shape. That is, the third lens 103 may have a meniscus shape convex toward the object side on the optical axis OA. Alternatively, on the optical axis OA, the fifth surface S5 may have a concave shape, and the sixth surface S6 may have a concave shape. Alternatively, the third lens 103 may have a meniscus shape convex toward the sensor. At least one or both of the fifth surface S5 and the sixth surface S6 may be aspherical. Aspheric coefficients of the fifth and sixth surfaces S5 and S6 are provided as shown in FIGS. 4a and 9a, L3 is the third lens 103, L3S1 is the fifth surface, and L3S2 is the sixth surface.

The effective diameter of the third lens 103 may be the smallest among lenses. The effective diameter may gradually increase from the third lens 103 to the first lens 101. The effective diameter may gradually increase from the third lens 103 to the seventh lens 107. Accordingly, the effective focal length of the optical system 1000 may be reduced and the FOV may be increased.

The fourth lens 104 may have positive (+) or negative (−) refractive power on the optical axis OA. The fourth lens 104 may have negative (−) refractive power. The fourth lens 104 may include a plastic or glass material. For example, the fourth lens 104 may be made of a plastic material. When an absolute value is expressed, the focal length of the fourth lens 104 may be greater than the focal length of the third lens 103, and for example, a condition may satisfy: 5<F3−|F7|<70. Here, the condition may satisfy: 20<F3<60. The fourth lens 104 may have the largest focal length among lenses.

The fourth lens 104 may include a seventh surface S7 defined as an object-side surface and an eighth surface S8 defined as a sensor-side surface. On the optical axis OA, the seventh surface S7 may have a concave shape, and the eighth surface S8 may have a convex shape. That is, the fourth lens 104 may have a meniscus shape that is convex toward the sensor side on the optical axis OA. Alternatively, the fourth lens 104 may have a concave shape on both sides of the optical axis. Alternatively, the fourth lens 104 may have a convex shape on both sides of the optical axis OA. At least one or all of the seventh and eighth surfaces S7 and S8 of the fourth lens 104 may be provided without a critical point. At least one of the seventh surface S7 and the eighth surface S8 may be an aspheric surface. For example, both the seventh surface S7 and the eighth surface S8 may be aspherical surfaces, and the aspherical surface coefficients are provided as shown in FIGS. 4a and 9a, L4 is the fourth lens 104, and L4S1 is the seventh surface, and L4S2 is the eighth surface.

An effective radius of the sixth surface S6 of the third lens 103 and/or the fourth surface S4 of the second lens 102 may be the smallest among the effective radii of the lenses. A difference in effective radii between the fourth surface S4 and the sixth surface S6 may be 0.15 mm or less. Accordingly, light loss due to the two lens surfaces facing each other in the region between the first and second lens groups LG1 and LG2 may be reduced.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be made of a plastic material.

The fifth lens 105 includes a ninth surface S9 on the object side and a tenth surface S10 on the sensor side, and the ninth surface S9 may have a convex shape on the optical axis OA. The tenth surface S10 may have a concave shape. That is, the fifth lens 105 may have a meniscus shape that is convex toward the object side on the optical axis OA. Alternatively, the fifth lens 105 may have a concave shape on both sides. Alternatively, the fifth lens 105 may have a meniscus shape that is convex toward the sensor. Alternatively, the fifth lens 105 may have a convex shape on both sides of the optical axis. At least one or all of the ninth and tenth surfaces S9 and S10 of the fifth lens 105 may have a critical point. At least one or both of the ninth surface S9 and the tenth surface S10 may be an aspheric surface, an aspherical surface coefficient is provided as shown in FIGS. 4a and 9a, L5 is the fifth lens 105, and LSS1 is the ninth surface, and L5S2 is the tenth surface.

The sixth lens 106 may have positive (+) or negative (−) refractive power on the optical axis OA. The sixth lens 106 may have negative (−) refractive power. The sixth lens 106 may include a plastic or glass material. For example, the sixth lens 106 may be made of a plastic material.

The sixth lens 106 may include an object-side eleventh surface S11 and a sensor-side twelfth surface S12. The eleventh surface S11 may have a convex shape on the optical axis OA, and the twelfth surface S12 may have a concave shape. That is, the sixth lens 106 may have a meniscus shape convex toward the object side. Alternatively, the sixth lens 1060 may have a concave shape on both sides of the optical axis OA. Alternatively, the sixth lens 1060 may have a meniscus shape convex toward the sensor. The sixth lens 106 may have a convex shape on both sides Alternatively, the both sides of the sixth lens 106 may have a convex shape. The eleventh and twelfth surfaces S11 and S12 of the sixth lens 106 may have a critical point. At least one or both of the eleventh surface S11 and the twelfth surface S12 may be an aspheric surface, and the aspherical surface coefficients are provided as shown in FIGS. 4a and 9a, where L6 is the sixth lens 106, L6S1 is the eleventh surface, and L6S2 is the twelfth surface.

The seventh lens 107 may have positive (+) or negative (−) refractive power on the optical axis OA. The seventh lens 107 is an n−1 th lens and may have positive (+) refractive power. The seventh lens 107 may include a plastic or glass material. For example, the seventh lens 107 may be made of a plastic material.

The seventh lens 107 may include an object-side thirteenth surface S13 and a sensor-side fourteenth surface S14. The thirteenth surface S13 may have a concave shape on the optical axis OA, and the fourteenth surface S14 may have a convex shape on the optical axis OA. That is, the seventh lens 107 may have a meniscus shape that is convex toward the sensor side on the optical axis OA. Alternatively, the seventh lens 107 may have a meniscus shape that is convex toward the object side. Alternatively, the seventh lens 107 may have a shape in which both sides are concave or both sides are convex on the optical axis OA. At least one or both of the thirteenth surface S13 and the fourteenth surface S14 of the seventh lens 107 may be a freeform surface, and the coefficients of the freeform surface are provided as shown in FIGS. 4b and 9b, where L7S1 is the thirteenth surface, and L7S2 is the fourteenth surface.

In an embodiment, the first to sixth lenses 101 to 106 having a rotationally symmetrical aspherical surface may be defined as a first lens portion, and the seventh and eighth lenses 107 and 108 having a non-rotationally symmetrical curved surface may be defined as a second lens portion. In addition, a distance between the seventh and eighth lenses 107 and 108 may be non-rotationally symmetrical, and the thickness of the seventh and eighth lenses 107 and 108 may also be non-rotationally symmetrical. Also, the distance between the first lens portion and the second lens portion may be non-rotationally symmetrical. The first to sixth lenses may have a rotationally symmetric aspherical surface.

As shown in FIG. 2, at least one or all of the thirteenth and fourteenth surfaces S13 and S14 of the seventh lens 107 may have critical points P1 and P2. For example, the thirteenth surface S13 may have a first critical point P1, and the fourteenth surface S14 may have a second critical point P2. The critical point is a point at which the sign of the slope value with respect to the optical axis OA and the direction perpendicular to the optical axis OA changes from positive (+) to negative (−) or from negative (−) to positive (+), and may mean a point at which the slope value is zero. Also, the critical point may be a point at which the slope value of a tangent passing through the lens surface decreases as it increases, or a point where the slope value increases as it decreases.

The eighth lens 108 may have negative (−) refractive power on the optical axis OA. The eighth lens 108 may include a plastic or glass material. For example, the eighth lens 108 may be made of a plastic material. The eighth lens 108 may be a lens closest to the sensor side of the optical system 1000 or a last n-th lens.

The eighth lens 108 may include an object-side fifteenth surface S15 and a sensor-side sixteenth surface S16. On the optical axis OA, the fifteenth surface S15 may have a concave shape, and the sixteenth surface S16 may have a convex shape. That is, the eighth lens 108 may have a meniscus shape convex toward the sensor side on the optical axis OA. Alternatively, the eighth lens 108 may have a convex meniscus shape or a concave shape on both sides from the optical axis toward the object side. The fifteenth and sixteenth surfaces S15 and S16 may be freeform surfaces, and the coefficients of the freeform surfaces are provided as shown in FIGS. 4b and 9b, L8S1 is the fifteenth surface, and L8S2 is the sixteenth surface.

At least one or both of the fifteenth and sixteenth surfaces S15 and S16 of the eighth lens 108 may have a critical point, for example, the fifteenth surface S15 may be provided without a critical point, and the sixteenth surface S16 may have a third critical point P3.

As shown in FIG. 2, a distance from the optical axis OA to the end of the effective region of each of the thirteenth surface S13 and the fourteenth surface S14 of the seventh lens 107 is an effective radius, which may be defined as r71 and r72. A distance from the optical axis OA to the end of the effective region of each of the fifteenth surface S15 and sixteenth surface S16 of the eighth lens 108 is an effective radius, and may be defined as r81 and r82.

The distances to the critical points of the thirteenth, fourteenth, fifteenth, and sixteenth surfaces S13, S14, S15, and S16 may be defined as follows.

Inf71: straight distance from the center of the thirteenth surface S13 to the first critical point P1

Inf72: straight distance from the center of the fourteenth surface S14 to the second critical point P2

Inf82: straight distance from the center of the sixteenth plane (S16) to the third critical point P3

Distances from the optical axis OA to the critical points P1, P2, and P3 may have the following relationship.

$$Inf 71 < Inf 72$$

$$Inf 82 < inf 71 < Inf 72$$

Accordingly, the seventh lens 107 may refract the light incident on the object-side surface to the periphery portion of the sensor-side surface. In addition, the sensor-side surface of the eighth lens 108 adjusts the refracting surface of light traveling to a region of 2 mm or less from the optical axis OA, so that deterioration in optical performance around the central portion may be prevented.

Here, the first critical points P1 may be disposed at the same distance or different distances from each other along different directions X and Y with respect to the optical axis OA. The second critical points P2 may be disposed at the same distance or different distances from each other along different directions X and Y with respect to the optical axis OA. The third critical points P3 may be disposed at the same distance or different distances from each other along different directions X and Y with respect to the optical axis OA. That is, the critical points may be located at the same or different distances along the first and second directions from the optical axis.

The effective radii r71, r72, and r82 and the distances Inf71, Inf72, and Inf82 to the critical points P1, P2, and P4 may satisfy the following relational expression from the optical axis.

$$0.27 < Inf 71 / r 71 < 0.47$$

$$0.33 < Inf 72 / r 72 < 0.53$$

$$0.12 < Inf 82 / r 82 < 0.32$$

The critical points of the first and second critical points P1 and P2 may be located within a range of 2.5 mm or less from the optical axis OA, for example, within a range of 1.3 mm to 2.5 mm, and the third critical point P3 may be located with a range 2 mm or less from the optical axis, for example, within the range of 0.1 mm to 2.0 mm.

The third critical point P3 may be positioned closer to the optical axis OA than the first and second critical points P1 and P2. Accordingly, the seventh lens 107 may refract the incident light to the periphery, and the eighth lens 108 may refract the incident light to the center and periphery portions of the image sensor 300.

It is preferable that the position of the critical point of the seventh and eighth lenses 107 and 108 are positioned to satisfy the above-mentioned range in consideration of the optical characteristics of the optical system 1000. In detail, the location of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

In addition, the normal line K2, which is a straight-line perpendicular to the tangent line K1 passing through an arbitrary point of the sixteenth surface S16 on the sensor-side surface of the eighth lens 108, which is the last lens, may have a predetermined angle θ1 from the optical axis OA, and the maximum angle of the angle θ1 may be greater than 5 degrees and less than 65 degrees, for example, in the range of 20 degrees to 50 degrees. Accordingly, since the Sag value in the sensor-side direction is not large based on a straight-line orthogonal to the optical axis of the sixteenth surface S16, a slim optical system may be provided.

Here, a normal line perpendicular to the tangent passing through the fifteenth surface S15 of the eighth lens 108 has a second angle θ2 with respect to the optical axis, a normal line perpendicular to the tangent passing through the fourteenth surface S14 of the seventh lens 107 has a third angle θ3 with respect to the optical axis, and a normal line perpendicular to the tangent passing through the thirteenth surface S13 of the seventh lens 107 has a fourth angle θ2 with respect to the optical axis. When the first to fourth angles θ1, θ2, θ3, and θ4 are maximum, the following relationship may be satisfied.

The following condition satisfies: θ1>θ2, and θ1 and θ2 may range from 50 degrees or less, for example, from 20 degrees to 50 degrees.

The following condition satisfies: θ3>θ4, and θ3 and θ4 may range from 50 degrees or less, for example, from 20 degrees to 50 degrees.

The following condition satisfies: θ3>θ1, and the following condition satisfies: 5<(θ3−θ1)<20.

The following condition satisfies: 0<(θ3−θ1)<10.

The following condition satisfies: 5<(θ1−θ2)<(θ3−θ4)<30.

Accordingly, the difference between the inclinations angle of the object-side surface and the sensor-side surface of the seventh lens 107 is large to refract light to the periphery portion, and the object-side surface and the sensor-side surface of the eighth lens 108 may be refracted. By reducing the difference between the inclination angles of the object-side surface and the sensor-side surface of the eighth lens 108, the light may be effectively guided to the region of the image sensor 300.

On the optical axis,

The curvature radii of the first and second surfaces S1 and S2 of the first lens 101 are L1R1 and L1R2,

The curvature radii of the third and fourth surfaces S3 and S4 of the second lens 102 are L2R1 and L2R2,

The curvature radii of the fifth and sixth surfaces S5 and S6 of the third lens 103 are L3R1 and L3R2,

The curvature radii of the seventh and eighth surfaces S7 and S8 of the fourth lens 104 are L4R1 and L4R2,

The curvature radii of the ninth and tenth surfaces S9 and S10 of the fifth lens 105 are L5R1 and L5R2,

The curvature radii of the eleventh and twelfth surfaces S11 and S12 of the sixth lens 106 are L6R1 and L6R2,

The curvature radii of the thirteenth and fourteenth surfaces S13 and S14 of the seventh lens 107 are L7R1 and L7R2, and

The curvature radii of the fifteenth and sixteenth surfaces S15 and S16 of the eighth lens 108 may be defined as L8R1 and L8R2. The curvature radii may satisfy at least one of the following conditions 1 to 9 in order to improve the aberration characteristics of the optical system.

L1R1<L2R2 Condition 1:

L2R1>L2R2 Condition 2:

L2R1+L3R1<L3R2 Condition 3:

L3R1*L3R2<|L4R1|<L3R1*L4R2 (however, L4R2<|L4R1|) Condition 4:

L6R1+L6R2<L5R2 Condition 5:

L7R1*L7R2<|L4R1| (however, the following relationship satisfies: L7R1,L7R2<0) Condition 6:

(|L8R1|+|L8R2|+|L7R1|+|L7R2|)<L5R2 Condition 7:

2*L5R2<|L4R1|<4*L4R1 Condition 8:

|L8R1|+|L8R2|<L6R1 Condition 9:

When expressed as an absolute value, the curvature radius of the first surface S1 of the first lens 101 on the optical system may be the minimum and may be 4 mm or less. The curvature radius (absolute value) of the seventh surface S7 of the fourth lens 104 may be the maximum and may be 200 mm or more. By setting such a curvature radius, good optical performance may be provided at the focal length of each lens.

The effective diameter of the eighth lens 108 may have a maximum effective diameter and may be 12 mm or more. The effective diameter of the eighth lens 108 is the average of the effective diameters of the object-side surface and the sensor-side surface. The effective diameter of the eighth lens 106 may be twice or more than the curvature radius (absolute value) of the fifth lens 105.

On the optical axis, the effective diameter of each lens may be defined as the clear aperture or effective diameter.

The effective diameters of the first to eighth lenses 101 to 108 may be defined as CA1, CA2, CA3, CA4, CA5, CA6, CA7, and CA8.

The effective diameters of the first and second surfaces S1 and S2 are CA11 and CA12,

The effective diameters of the third and fourth surfaces S3 and S4 are CA21 and CA22,

The effective diameters of the fifth and sixth surfaces S5 and S6 are CA31 and CA32,

The effective diameters of the seventh and eighth surfaces S7 and S8 are CA41 and CA42,

The effective diameters of the ninth and tenth surfaces S9 and S10 are CA51 and CA52,

The effective diameters of the 11th and 12th surfaces S11 and S12 are CA61 and CA62,

The effective diameters of the thirteenth and fourteenth surfaces S13 and S14 are CA71 and CA72,

The effective diameters of the fifteenth and sixteenth surfaces S16 and S16 may be defined as CA81 and CA82. These effective diameters are factors that affect the aberration characteristics of the optical system, and may satisfy at least one of the following conditions.

CA3<CA2<CA1 Condition 1:

CA3<CA4<CA5<CA6<CA7<CA8 Condition 2:

CA32<CA31<CA21<CA11 condition 3;

CA32<CA42<CA52<CA62<CA72<CA82 Condition 4:

1<(CA62−CA61)<3 Condition 5:

(CA51−CA42)<(CA62−CA61) Condition 6:

L1R1+L2R2<CA82 Condition 7:

Among the first to eighth lenses 101 to 108, the third lens 103 may have the smallest average size of the effective diameters of the lenses, and the eighth lens 108 may have the largest average size. The size of the effective diameter of the fourth surface S4 or the sixth surface S6 may be the smallest, and the size of the effective diameter of the sixteenth surface S16 may be the largest. Since the size of the effective diameter of the eighth lens 108 is the largest, incident light may be effectively refracted toward the image sensor 300. Accordingly, the optical system 1000 may have improved chromatic aberration control characteristics, and may improve vignetting characteristics of the optical system 1000 by controlling incident light.

In the optical system, the number of lenses having a refractive index exceeding 1.6 may be two or more, and the number of lenses having a refractive index of less than 1.6 may be four or more. The average refractive index of the first to eighth lenses 101 to 108 may be 1.55 or more. In the optical system, the number of lenses having an Abbe number greater than 45 may be two or more, and may be smaller than the number of lenses having an Abbe number of less than 45. An average Abbe number of the first to eighth lenses 101 to 108 may be 45 or less. By setting the refractive index and Abbe number of each lens, the effect of chromatic aberration may be controlled.

Referring to FIG. 2, a back focal length (BFL) is an optical axis distance from the image sensor 300 to the last lens. That is, the BFL is the optical axis distance between the image sensor 300 and the sensor-side sixteenth surface S16 of the eighth lens 108. CT7 is a center thickness or a thickness in the optical axis of the seventh lens 107, and L7_ET is the end or edge thickness of the effective region of the seventh lens 107. CT8 is a center thickness or a thickness in the optical axis of the eighth lens 108. CG7 is an optical axis distance between the seventh lens 107 and the eighth lens 108 (i.e., center distance). That is, the optical axis distance CG7 between the seventh lens 107 and the eighth lens 108 is the optical axis distance between the fourteenth surface S14 and the fifteenth surface S15 in the optical axis OA.

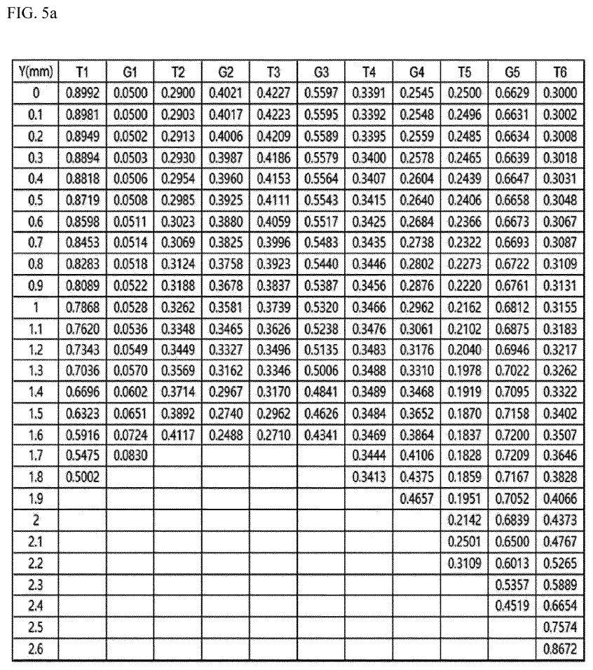

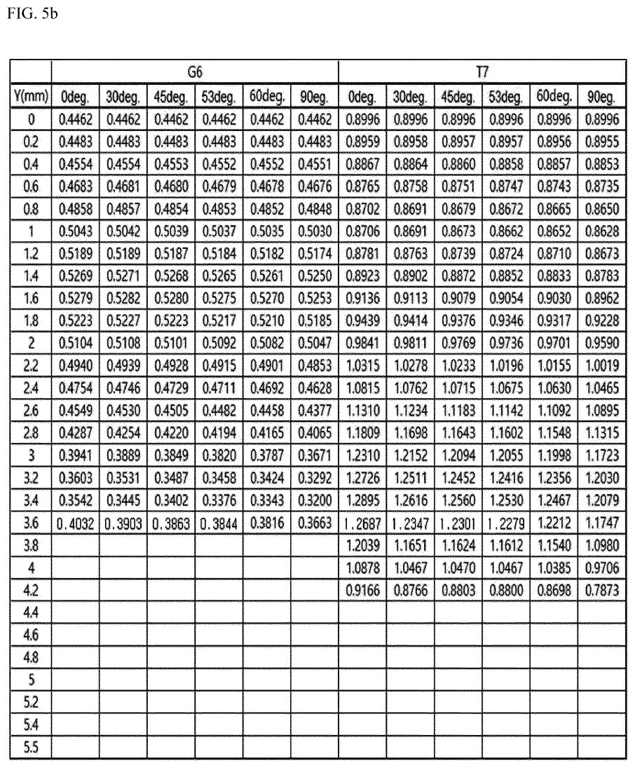

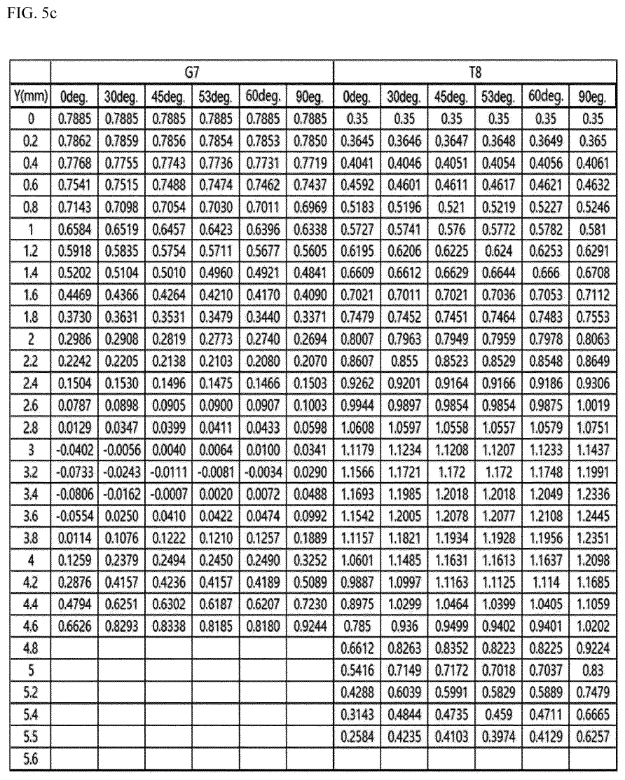

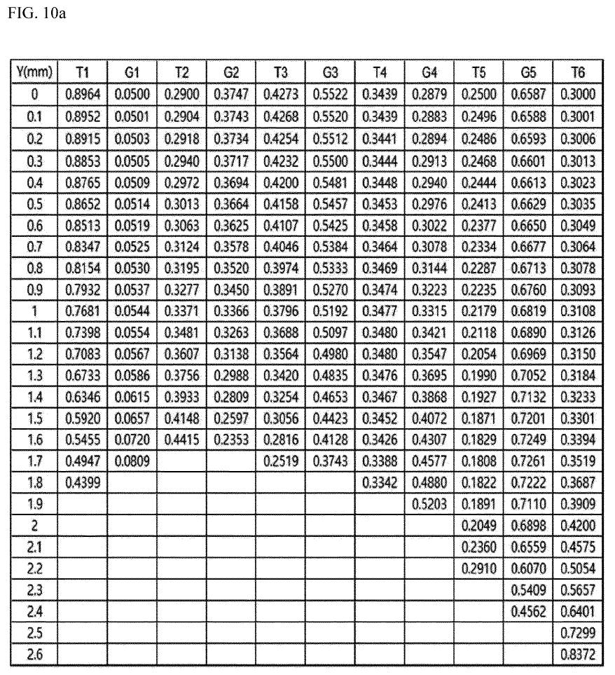

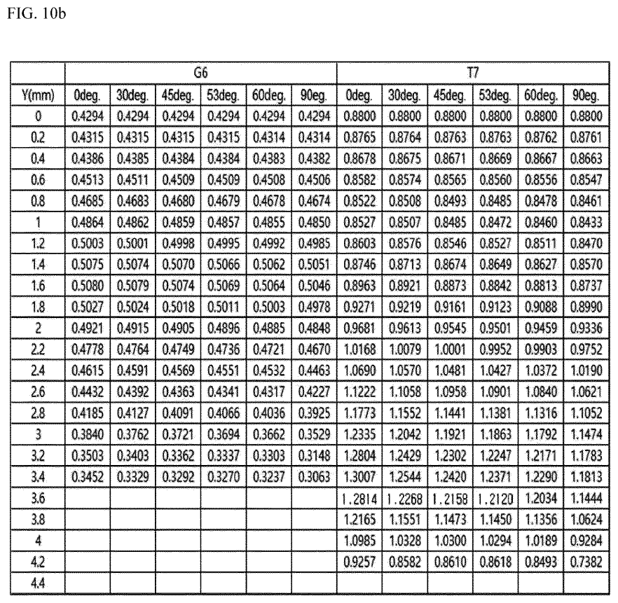

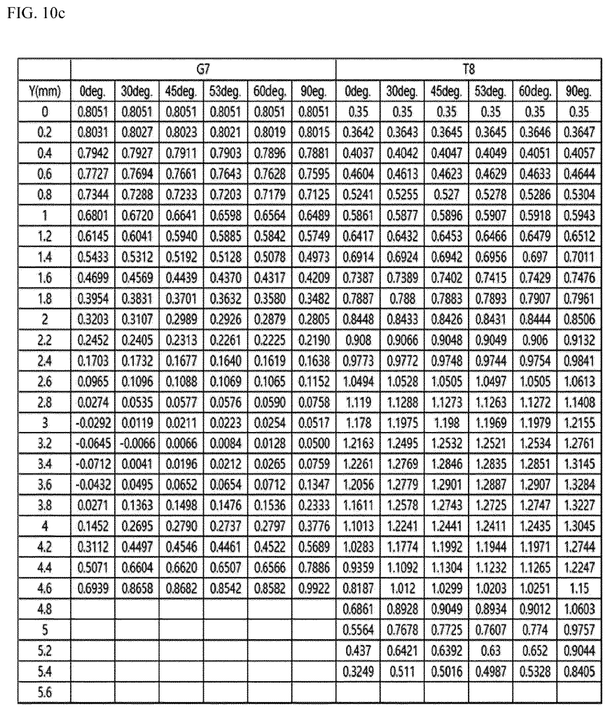

As shown in FIGS. 5a, 5b, 5c, 10a, 10b, and 10c, the thickness of the first to eighth lenses 101 to 108 is T1-T8, and the center thickness may be defined as CT1-CT8. The edge thickness, which is the edge thickness of the effective region of the first to eighth lenses 101 to 108, may be defined as ET1 to ET8. The distance between the two adjacent lenses is G1-G7 in the order of the first lens to the eighth lens, and the center distances may be defined as CG1-CG7.

The thickness and the distance of each lens may satisfy the following conditions.

CG3<GG7<(2*CG3) (in the specification, * is a product) Condition 1:

(CG2+CG4)<CT1 Condition 2:

(CT2+CT3+CT4+CT5+CT6)<(CT1+CT7) Condition 3:

CG7≤CT7 Condition 4:

(CT6+CT8)<CG7<CT7 Condition 5:

ΣCG<ΣCT Condition 6:

0<Max_CT−Max_CG<0.3 Condition 6:

ΣCG is the sum of the center distances CG1 to GG7 between two adjacent lenses, ΣCT is the sum of the center thicknesses CT1 to CT8 of each lens, and Max_CT is the maximum thickness among the center thicknesses CT1 to CT8 of each lens, and Max_CG is the maximum distance among center distances CG1 to GG7 of adjacent lenses. In addition, the optical system 1000 that satisfies the above conditions may control incident light and may have improved aberration characteristics and resolution.

The seventh distance CG7 may be the largest among optical axis distances between two adjacent lenses. CG7 may be 30% or more of the optical axis distance from the first surface S1 of the first lens 101 to the fourteenth surface S14 of the seventh lens 107, for example, in a range of 30% to 46%. By increasing the optical axis distance CG7 between the seventh and eighth lenses 107 and 108 and the center thickness of the seventh lens 107, a slim optical system with improved optical performance may be provided.

The center distance CG7 between the seventh lens 107 and the eighth lens 108 is the maximum among the distances between the lenses, and the optical axis distance CG1 between the first and second lenses 101 and 102 is the smallest of the optical axis distances among the first to eighth lenses 101 to 108, the lens having the maximum center thickness may be the first lens 101 or the seventh lens 107, and the lens having the minimum center thickness may be the fifth lens 105.

Among the lenses 101 to 108, the maximum center thickness may be twice or more, for example, 2 to 5 times the minimum center thickness. Among the lenses, the number of lenses having a center thickness of less than 0.5 mm may be greater than the number of lenses having a center thickness of 0.5 mm or more, and is four or more. The average of the center thickness of the lenses may be less than 0.5 mm. The optical system 1000 having the image sensor 300 with a size of around 1 inch may be provided in a structure having a slim thickness.

The total effective focal length of the optical system 100 is F, the focal lengths of each lens 101-108 are defined as F1, F2, F3, F4, F5, F6, F7, F8, and based on the absolute values, the following conditions may satisfy: F2<F4, F1<F3, and F8<F5<F6<F4. The resolution may be affected by adjusting the focal length. When the focal length is described as an absolute value, the focal length of the fourth lens 104 may be the largest among the lenses, the focal length of the eighth lens 108 is the minimum, and a difference between the focal lengths of the seventh and eighth lenses 107 and 108 may be 8 or less. The maximum focal length may be 20 times or more than the minimum focal length.

Here, the total effective focal length F includes a focal length Fx in a first direction X perpendicular to the optical axis OA and a focal length Fy in a second direction Y perpendicular to the optical axis OA, and the following condition may satisfy: 0≤|Fx−Fy|≤0.1. In this case, the total effective focal length F is an average of focal lengths in the first and second directions. When the focal length of the second lens group LG2 in the first direction is Fx48 and the focal length in the second direction is Fy48, the following condition may satisfy: 0≤|Fx48−Fy48|<0.15. Preferably, Fx≠Fy and Fx48≠Fy48 may be satisfied.

The refractive index of each lens 101-108 is n1, n2, n3, n4, n5, n6, n7, n8, the Abbe number of each lens 101-108 is ν1, ν2, ν3, ν4, ν5, ν6, In the case of ν7 and ν8, the refractive index may satisfy at least one of the following conditions.

n1<n2 Condition 1:

1.65<n2 Condition 2:

(n1*ν1)>(n2*ν2) Condition 3:

(n5*ν5)<(n3*ν3) Condition 4:

(n7*ν7)<(n8*ν8) Condition 5:

ν6<ν8<ν1 Condition 6:

The conditions may be satisfied, n1, n3, n8 are less than 1.6 and may have a difference of 0.2 or less from each other, and n2, n4 are greater than 1.60. The Abbe number may satisfy the condition: ν2<ν3, ν1, ν2, and ν8 may be 45 or more and may have a difference of 30 or less from each other, and ν2 may be less than 45, for example, 30 or less. Accordingly, the optical system 1000 may have improved chromatic aberration control characteristics.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure. Hereinafter, the unit of the focal length, thickness, spacing, curvature radius, and effective diameter is mm.

$$1 < CT 1 / CT 2 < 5 \qquad [ Equation 1 ]$$

When the center thickness CT1 of the first and second lenses 101 and 102 is satisfied in Equation 1, the optical system 1000 may improve aberration characteristics. Preferably, Equation 1 may satisfy: 2<CT1/CT2<4, and if the range is exceeded, the TTL increases, and if the range is smaller than the range, resolution may be affected.

$$0.5 < CT 3 / ET 3 < 3 \qquad [ Equation 2 ]$$

In Equation 2, when the center thickness CT3 and the edge thickness ET3 of the third lens 103 are satisfied, the optical system 1000 may have improved chromatic aberration control characteristics. Preferably, Equation 2 above may satisfy: 1<CT3/ET3<2.

$$1 < CT 1 / ET 1 < 3 \qquad [ Equation 2 - 1 ]$$

$$0 < CT 2 / ET 2 < 1. 5 \qquad [ Equation 2 - 2 ]$$

$$( CT 2 + CT 3 ) < CT 1 \qquad [ Equation 2 - 3 ]$$

$$0.8 < CT 4 / ET 4 < 2 \qquad [ Equation 2 - 4 ]$$

$$0 < CT 5 / ET 5 < 1.5 \qquad [ Equation 2 - 5 ]$$

$$0.8 < CT 6 / ET 6 < 1. 2 \qquad [ Equation 2 - 6 ]$$

$$1.5 < CT 7 / ET 7 < 4 \qquad [ Equation 2 - 7 ]$$

$$0.8 < CT 8 / ET 8 < 2 \qquad [ Equation 2 - 8 ]$$

$$0.5 < SD / TD < 1 \qquad [ Equation 2 - 9 ]$$

When the ratio of the center thickness to the edge thickness of the second to eighth lenses 102 to 108 in Equations 2-1 to 2-8 is satisfied, the optical system 1000 may have improved chromatic aberration control characteristics.

The SD is the optical axis distance from the aperture stop to the sixteenth surface S16 on the sensor side of the eighth lens 108, and the TD is an optical axis distance from the object-side first surface S1 of the first lens 101 to the sensor-side sixteenth surface S16 the eighth lens 108. The aperture stop may be disposed around the object-side surface of the second lens 102. When the optical system 1000 according to the embodiment satisfies Equation 2-9, chromatic aberration of the optical system 1000 may be improved.

$$1 < FLG 1 / \vert FLG 2 \vert < 5 \qquad [ Equation 2 - 10 ]$$

The FLG1 is the focal length of the first lens group LG1, and the FLG2 is the focal length of the second lens group LG2. When the optical system 1000 according to the embodiment satisfies Equation 2-10, chromatic aberration of the optical system 1000 may be improved. That is, as the value of Equation 2-10 approaches 1, the distortion aberration may be reduced. The value of Equation 2-10 may satisfy: 1<FLG2/FLG1<3.

$$0 < ET 8 / CT 8 < 3 \qquad [ Equation 3 ]$$

In Equation 3, when the thickness CT8 of the optical axis and the thickness ET8 of the edge of the eighth lens 108 are satisfied, the optical system 1000 may have improved chromatic aberration control characteristics. Equation 3 may satisfy: 0<ET8/CT8<1.

$$1.6 < n 2 \qquad [ Equation 4 ]$$

In Equation 4, n2 means the refractive index of the second lens 102 at the d-line. When the optical system 1000 according to the embodiment satisfies Equation 4, the optical system 1000 may improve chromatic aberration characteristics.

$$1.5 < n 1 < 1 \text{.60} \qquad [ Equation 4 - 1 ]$$

$$1.5 < n 8 < 1.60$$

In Equation 4-1, n1 is the refractive index of the first lens 101 at the d-line, and n8 is the refractive index of the eighth lens 108 at the d-line. When the optical system 1000 according to the embodiment satisfies Equation 4-1, the effect on the TTL of the optical system 1000 may be suppressed.

$$1.5 < n 3 < 1 \text{.60} \qquad [ Equation 4 - 2 ]$$

$$1.6 < n 4$$

In Equation 4-2, n2 and n4 are the refractive indices of the second and fourth lenses 102 and 104 at the d-line. When the optical system 1000 according to the embodiment satisfies Equation 4-2, the optical system 1000 may improve chromatic aberration characteristics.

$$0.5 < L 8 S 2 \_max \_Sag to Sensor < 1.5 \qquad [ Equation 5 ]$$

In Equation 5, L8S2_max_Sag to Sensor means the distance from the maximum Sag value in the sensor-side surface of the eighth lens 108 to the image sensor 300 in the optical axis direction. For example, L8S2_max_Sag to Sensor means the distance from the third critical point P3 in the sensor-side surface of the eighth lens 108 to the image sensor 300 in the optical axis direction. When the optical system 1000 according to the embodiment satisfies Equation 5, the optical system 1000 may secure a space in which the optical filter 500 may be disposed between the lens portion 100 and the image sensor 300, thereby having improved assemblability. In addition, when the optical system 1000 satisfies Equation 5, the optical system 1000 may secure a distance for module manufacturing. Preferably, the value of Equation 5 may satisfy: 0.5<L8S2_max_sag to Sensor<1.

In the lens data for the embodiment, the position of the filter 500, in detail, the distance between the last lens and the filter 500, and the distance between the image sensor 300 and the filter 500 are set for convenience in the design of the optical system 1000, and the filter 500 may be freely disposed within a range in which the last lens and the image sensor 300 do not come into contact. Accordingly, the value of the L8S2_max_Sag to Sensor in the lens data may be smaller than the BFL (Back focal length) of the optical system 1000, and the position of the filter 500 may move within a range that is not contact the last lens and the image sensor 300, respectively, and have good optical performance. That is, the distance between the critical point P3 and the image sensor 300 of the sixteenth surface S16 of the eighth lens 108 is the minimum, and may gradually increase toward the end of the effective region.

$$0.8 < BFL / L 8 S 2 \_max \_Sag to Sensor < 2 \qquad [ Equation 6 ]$$

In Equation 6, BFL means the distance (unit: mm) in the optical axis OA from the center of the sixteenth surface S16 of the eighth lens 108 to the image surface of the image sensor 300. When the optical system 1000 according to the embodiment satisfies Equation 6, the optical system 1000 may improve distortion aberration characteristics and may have good optical performance in the periphery portion of the FOV. Here, the maximum Sag value of L8S2 on the sensor-side direction may be the height from the directions X and Y orthogonal to the optical axis OA to the critical point P3. Equation 6 may satisfy: 1<BFL/L8S2_max_sag to Sensor<1.5.

$$5 < \vert L 8 S 2 \_max slope \vert < 65 \qquad [ Equation 7 ]$$

In Equation 7, L8S2_max slope means the maximum value (Unit: degree) of the tangential angle measured on the sensor-side sixteenth surface S16 of the eighth lens 108. In detail, in the sixteenth surface S16, the L8S2_max slope means an angle value (Unit: degree) at a point having the largest tangential angle with respect to a virtual line extending in a direction perpendicular to the optical axis OA, and in FIG. 2 represents the maximum 01. When the optical system 1000 according to the embodiment satisfies Equation 7, the optical system 1000 may control the occurrence of lens flare. Preferably, Equation 7 may satisfy: 20<|L8S2_max slope|≤45.

$$0.5 < Inf 82 < 2 \qquad [ Equation 8 ]$$

In Equation 8, Inf82 is a distance from the optical axis OA to the critical point P3 of the sixteenth surface S15 of the eighth lens 108. The Inf82 may be located within 1.3 mm+0.2 mm from the optical axis OA. When the optical system 1000 according to the embodiment satisfies Equation 8, the influence on the slim rate of the optical system 1000 may be suppressed.

$$1 < CG 7 / G 7 \_min < 20 \qquad [ Equation 9 ]$$

In Equation 9, CG7 is a center distance between the seventh lens 107 and the eighth lens 108, and G7_min means the minimum distance in the distance G7 between the seventh lens 107 and the eighth lens 108. When the optical system 1000 according to the embodiment satisfies Equation 9, the optical system 1000 may improve distortion aberration characteristics and may have good optical performance in the periphery portion of the FOV. Equation 9 may satisfy: 5<CG7/G7_min<15.

$$0 < CG 7 / EG 7 < 5 \qquad [ Equation 10 ]$$

In Equation 10, when the optical axis distance CG7 between the seventh and eighth lenses 107 and 108 and the optical axis distance EG8 at the end of the effective region between the seventh and eighth lenses 107 and 108 are satisfied, it may have good optical performance even in the center and periphery portions of the FOV. In addition, the optical system 1000 may reduce distortion and thus have improved optical performance. Preferably, Equation 10 may satisfy: 1<CG7/EG7<2.

$$0 < CG 1 / CG 7 < 1 \qquad [ Equation 11 ]$$

In Equation 11, when the optical axis distance CG1 between the first lens 101 and the second lens 102 and the optical axis distance CG7 between the seventh and eighth lenses 107 and 108 are satisfied, the optical system 1000 may improve aberration characteristics and control TTL reduction. Preferably, Equation 11 may satisfy: 0<CG1/CG7<0.5.

$$5 < CA 82 / CG 7 < 20 \qquad [ Equation 11 - 1 ]$$

In Equation 11-1, CA82 is the effective diameter of the largest lens surface, and is the effective diameter of the sixteenth surface S16 of the eighth lens 108. When the optical system 1000 according to the embodiment satisfies Equation 11-1, the optical system 1000 may improve aberration characteristics and control TTL reduction. Preferably, Equation 11-1 may satisfy: 10<CA82/CG7<20.

$$5 < CA 72 / CG 7 < 16 \qquad [ Equation 11 - 2 ]$$

Equation 11-2 may set the effective diameter CA72 of the fourteenth surface S14 of the seventh lens 107 and the optical axis distance CG7 between the seventh and eighth lenses 107 and 108. When Equation 11-2 is satisfied, the optical system may improve aberration characteristics and control TTL reduction. Preferably, Equation 11-2 may satisfy: 8<CA72/CG7<14.

$$0 < CT 1 / CT 7 < 2 \qquad [ Equation 12 ]$$

In Equation 12, when the center thickness CT1 of the first lens 101 and the center thickness CT7 of the seventh lens 107 are satisfied, the optical system 1000 may have improved aberration characteristics. In addition, the optical system 1000 has good optical performance at a set FOV and may control a TTL. Preferably, Equation 12 may satisfy: 0.5<CT1/CT7<1.5.

$$0 < C T 6 / CT 7 < 1 \qquad [ Equation 13 ]$$

In Equation 13, when the center thickness CT6 of the sixth lens 106 and the center thickness CT7 of the seventh lens 107 are satisfied, the optical system 1000 may reduce the manufacturing precision of the sixth, seventh, and eighth lenses, and improve optical performance of the center and periphery portions of the FOV. Preferably, Equation 13 may satisfy: 0.1<CT6/CT7<0.6. The center thickness of the fifth, sixth, and seventh lenses may satisfy the condition: (CT5+CT6)<CT7. In addition, the center thicknesses of the first, sixth, seventh, and eighth lenses may satisfy the conditions: (CT6+CT8)<CT7 and |CT7−CT1|<0.3, and thus the TTL may be reduced.

$$0 < CT 7 - CG 7 < 0.4 \qquad [ Equation 13 - 1 ]$$

In Equation 13-1, TTL may be reduced by setting the center thickness CT7 of the seventh lens 107 and the optical axis distance CG7 between the seventh and eighth lenses.

$$0 < \vert L 7 R 2 / L 8 R 1 \vert < 2 \qquad [ Equation 14 ]$$

In Equation 14, L7R2 means the curvature radius on the optical axis of the fourteenth surface S14 of the seventh lens 107, and L8R1 means the curvature radius on the optical axis of the fifteenth surface S15 of the eighth lens 108. When Equation 14 is satisfied, the aberration characteristics of the optical system 1000 may be improved. Preferably, Equation 14 may satisfy: 0.5<|L7R2/L8R1|<1.

$$0 < ( CG 7 - EG 7 ) / ( CG 7 ) < 2 \qquad [ Equation 15 ]$$

When Equation 15 satisfies the center distance CG7 and the edge distance EG7 between the seventh and eighth lenses 107 and 108, the optical system 1000 may reduce distortion and have improved optical performance. When Equation 15 is satisfied, optical performance of the center and periphery portions of the FOV may be improved. Equation 15 may preferably satisfy: 0.1< (CG7−EG7)/(CG7)<0.5. Here, the center distances (CG) between the fourth to eighth lenses may satisfy a condition: CG4<CG6<CG5<CG7.

$$0.5 < CA 11 / CA 22 < 2 \qquad [ Equation 16 ]$$

In Equation 16, CA11 means the effective diameter CA (clear aperture) of the first surface S1 of the first lens 101, and CA22 means the effective diameter of the fourth surface S4 of the second lens 102. When Equation 16 is satisfied, the optical system 1000 may control light incident to the first lens group LG1 and may have improved aberration control characteristics. Equation 16 may preferably satisfy: 0.5<CA11/CA22<1.5.

$$1 < CA 72 / CA 31 < 5 \qquad [ Equation 17 ]$$

In Equation 17, CA31 means the effective diameter of the fifth surface S5 of the third lens 103, and CA72 means the effective diameter of the fourteenth surface S14 of the seventh lens 107. When Equation 17 is satisfied, the optical system 1000 may control light incident to the second lens group LG2 and may improve aberration characteristics. Preferably, Equation 17 may satisfy: 2<CA72/CA31<3.

$$0.5 < CA 32 / CA 41 < 2 \qquad [ Equation 18 ]$$

In Equation 18, when the effective diameter CA32 of the sixth surface S4 of the third lens 103 and the effective diameter CA41 of the seventh surface S7 of the fourth lens 104 are satisfied, a difference in effective diameters between the first and second lens groups LG1 and LG2 may be reduced, and light loss may be suppressed. In addition, the optical system 1000 may improve chromatic aberration and control vignetting for optical performance. Preferably, Equation 18 may satisfy: 0.7<CA32/CA41<1.3.

$$0.1 < CA 52 / CA 72 < 1 \qquad [ Equation 19 ]$$

In Equation 19, when the effective diameter CA52 of the tenth surface S10 of the fifth lens 105 and the effective diameter CA72 of the fourteenth surface S14 of the seventh lens 107 are satisfied, the light path traveling in the second lens group LG2 may be set, and chromatic aberration may be improved. Preferably, Equation 19 may satisfy: 0.4≤CA52/CA72≤0.8.

$$1 < CA 82 / CA 11 < 5 \qquad [ Equation 20 ]$$

In Equation 20, when the effective diameter CA81 of the sixteenth surface S16 of the eighth lens 109 and the effective diameter CA11 of the first surface S1 of the first lens 101 are satisfied, the effective diameters between the incident-side lens and the last lens may set. Accordingly, the optical system 1000 may set FOV and a size of the optical system. Preferably, Equation 20 may satisfy: 2.5<CA82/CA11<3.5.

$$0 < CG 3 / EG 3 < 5 \qquad [ Equation 21 ]$$

In Equation 21, when the optical axis distance CG3 between the third and fourth lenses 103 and 104 and the edge distance EG3 between the third and fourth lenses 103 and 104 in the optical axis OA are satisfied, the optical system 1000 may reduce chromatic aberration, improve aberration properties, and control vignetting for optical performance. Preferably, Equation 21 may satisfy: 1<CG3/EG3<1.6.

$$1 < CG 6 / EG 6 < 5 \qquad [ Equation 22 ]$$

In Equation 22, when the center distance CG6 and the edge distance EG6 between the sixth and seventh lenses 106 and 107 are satisfied, the optical system may have good optical performance even at the center and the periphery portions of the FOV, distortion occurrence may be prevented. Preferably, it may satisfy: 2<CG6/EG6<4.5.

At least one of Equations 21 and 22 may further include at least one of Equations 22-1 to 22-6.

$$0 < CG 1 / EG 1 < 1 \qquad [ Equation 22 - 1 ]$$

$$1 < CG 2 / EG 2 < 2.5 \qquad [ Equation 22 - 2 ]$$

$$0 < CG 4 / EG 4 < 1.5 \qquad [ Equation 22 - 3 ]$$

$$5 < CG 5 / EG 5 < 10 \qquad [ Equation 22 - 4 ]$$

$$25 < ( CG 6 / EG 6 ) * n < 40 \qquad [ Equation 22 - 5 ]$$

$$0.5 < CG 8 / EG 8 < 2 \qquad [ Equation 22 - 6 ]$$

Here, n is the total number of lenses. By setting the center distance and the edge distance between adjacent lenses, TTL may be reduced and the incident light may be refracted to the periphery portion of the image sensor.

$$0 < G 7 \_max / CG 7 < 2 \qquad [ Equation 23 ]$$

In Equation 23, G7_Max means the maximum distance among the distances G7 between the seventh and eighth lenses 107 and 108. When the optical system 1000 according to the embodiment satisfies Equation 23, optical performance may be improved in the periphery portion of the FOV, and distortion of aberration characteristics may be suppressed. Preferably, Equation 23 may satisfy: 0.5<G7_max/CG7<1.5.

$$0 < CT 7 / CG 7 < 2 \qquad [ Equation 24 ]$$

In Equation 24, when the center thickness CT7 of the seventh lens 107 and the center distance CG7 between the seventh and eighth lenses 107 and 108 are satisfied, the optical system 1000 may be set the maximum optical axis distance CG7 and the center thickness of the seventh lens, and optical performance of the periphery portion of the FOV may be improved. Preferably, Equation 24 may satisfy: 0.5<CT7/CG7<1.5.

$$1 < CT 7 / CG 6 < 3 \qquad [ Equation 25 ]$$

In Equation 25, when the center thickness CT7 of the seventh lens 107 and the center distance CG7 between the seventh and eighth lenses 107 and 108 are satisfied, the optical system 1000 may reduce the effective diameters and the distances between the six and seventh lenses and improve the optical performance of the periphery portion of the FOV. Preferably, Equation 25 may satisfy: 1.5<CG7/CT6<2.5.

$$0.1 < CT 8 / CG 7 < 1 \qquad [ Equation 26 ]$$

When Equation 26 satisfies the center thickness CT8 of the eighth lens 108 and the distance CG8 between the seventh and eighth lenses 107 and 108, the optical system 1000 may reduce the center distance between the seventh and eighth lenses and the center thickness of the eighth lens 108, and improve the optical performance of the periphery portion of the FOV. Preferably, Equation 26 may satisfy: 0<CT8/CG7<0.8.

$$10 < L 6 R 2 / CT 6 < 70 \qquad [ Equation 27 ]$$

When Equation 27 satisfies the curvature radius L6R2 of the twelfth surface S12 of the sixth lens 106 and the thickness CT6 in the optical axis of the sixth lens 106, the optical system 1000 may control the refractive power of the sixth lens 106, and may improve optical performance of light incident to the second lens group LG2. Preferably, Equation 27 may satisfy: 30<L6R2/CT6<60. Preferably, the condition may satisfy: L6R1>L6R2.

$$2 < \vert L 6 R 1 / L 8 R 1 \vert < 10 \qquad [ Equation 28 ]$$

When Equation 28 satisfies the curvature radius L6R1 of the eleventh surface S11 of the sixth lens 106 and the curvature radius L8R1 of the fifteenth surface S15 of the eighth lens 108, The shape and refractive power of the sixth and eighth lenses may be controlled and optical performance may be improved, and the optical performance of the second lens group LG2 may be improved. Preferably, Equation 28 may satisfy: 2<|L6R1/L8R1|<4. Preferably, the conditions may satisfy: L6R1>0 and L8R1<0.

$$0 < L 1 R 1 / L 1 R 2 < 1 \qquad [ Equation 29 ]$$

Equation 29 may set the curvature radii L1R1 and L1R2 of the first surface S1 and the second surface S2 of the first lens 101, and when these are satisfied, the lens size and resolving power may be determined. Preferably, Equation 29 may satisfy: 0.1<LIR1/LIR2≤0.5. Preferably, L1R1>0 and L1R2>0 may be satisfied.

$$0 < L 2 R 2 / L 2 R 1 < 2 \qquad [ Equation 30 ]$$

Equation 30 may set the curvature radii L2R1 and L2R2 of the third and fourth surfaces S3 and S4 of the second lens 102, and when they are satisfied, the resolving power of the lens may be determined. Preferably, Equation 30 may satisfy: 0.3<L2R2/L2R1<1. Preferably, L2R1>0 and L2R2>0 may be satisfied.

At least one of Equations 28, 29, and 30 may include at least one of Equations 30-1 to 30-6 below, and resolution of each lens may be determined.

$$0 < L 3 R 1 / L 3 R 2 < 1 \qquad [ Equation 30 - 1 ]$$

$$2 < \vert L 4 R 1 / L 4 R 2 \vert < 10 \qquad [ Equation 30 - 2 ]$$

$$0 < \vert L 5 R 1 / L 5 R 2 \vert < 1 \qquad [ Equation 30 - 3 ]$$

$$1 < \vert L 6 R 1 / L 6 R 2 \vert < 5 \qquad [ Equation 30 - 4 ]$$

$$0.5 < L 7 R 1 / L 7 R 2 < 2 \qquad [ Equation 30 - 5 ]$$

$$0.5 < L 8 R 2 / L 8 R 1 < 2 \qquad [ Equation 30 - 6 ]$$

Preferably, the conditions may satisfy: L4R1<0, L4R2>0, L7R1<0, and L8R2<0.

$$0 < CT\_Max / CG\_Max < 2 \qquad [ Equation 31 ]$$

In Equation 31, the largest thickness CT_max in the optical axis OA of each of the lenses and the maximum center distance CG_max or the air gaps in the optical axis between the plurality of lenses are satisfied. In this case, the optical system 1000 has good optical performance at the set FOV and focal length, and the size of the optical system 1000 may be reduced, for example, a TTL may be reduced. Preferably, Equation 31 may satisfy: 0.5<CT_Max/CG_Max<1.5.

$$0 < Σ CT / Σ CG < 2 \qquad [ Equation 32 ]$$

In Equation 32, ECT means the sum of thicknesses (unit: mm) in the optical axis OA of each of the plurality of lenses, and ECG means the sum of the distances in the optical axis OA between two adjacent lenses in the plurality of lenses. When the optical system 1000 according to the embodiment satisfies Equation 32, the optical system 1000 has good optical performance at the set FOV and focal length, and reduces the size of the optical system 1000, for example, TTL. Preferably, Equation 32 may satisfy: 1<ECT/ECG<1.5.

$$10 < Σ Index < 30 \qquad [ Equation 33 ]$$

In Equation 33, ΣIndex means the sum of the refractive indices at the d-line of each of the plurality of lenses. When the optical system 1000 according to the embodiment satisfies Equation 33, the TTL of the optical system 1000 may be controlled and resolution may be improved. Here, the average refractive index of the first to eighth lenses 101 to 108 may be 1.50 or more. Preferably, Equation 33 may satisfy: 10<ΣIndex<20, and may satisfy the condition: 80<ΣIndex*n, where n is the total number of lenses.

$$10 < Σ Abbe / Σ Index < 50 \qquad [ Equation 34 ]$$

In Equation 34, ΣAbbe means the sum of Abbe numbers of each of the plurality of lenses. When the optical system 1000 according to the embodiment satisfies Equation 34, the optical system 1000 may have improved aberration characteristics and resolution. An average Abbe number of the first to eight lenses 101 to 108 may be 45 or less. Preferably, Equation 34 may satisfy: 20<ΣAbbe/ΣIndex<40.

$$FOV < ( Σ Index * nL ) \qquad [ Equation 35 ]$$

In Equation 35, FOV is set to be smaller than the sum of the refractive indices of each lens multiplied by the number of lenses, so that the refractive power according to the FOV of the optical system may be set. Here, the condition may satisfy: (ΣIndex*nL)<ΣCA, and ΣCA is the sum of the effective diameters of the object-side and sensor-side surfaces of each lens.

$$0 < EG\_Max / CT\_Max < 3 \qquad [ Equation 36 ]$$

In Equation 36, CT_max means the thickest center thickness of each of the plurality of lenses, and EG_Max is the maximum edge distance between two adjacent lenses. When Equation 36 is satisfied, the optical system 1000 has a set FOV and focal length, and may have good optical performance in the periphery portion of the FOV. Preferably, Equation 36 may satisfy: 0<EG_Max/CT_Max<1.

$$0.5 < CA 11 / CA\_min < 2 \qquad [ Equation 37 ]$$

In Equation 37, when the effective diameter CA11 of the first surface S1 of the first lens 101 and the minimum effective diameter CA_Min of the lens surfaces are satisfied, light incident through the first lens 101 may be controlled to provide a slim optical system while maintaining optical performance. Preferably, Equation 37 may satisfy: 1<CA11/CA_min<1.5.

$$1 < CA\_max / CA\_min < 5 \qquad [ Equation 38 ]$$

In Equation 38, CA_max means the largest effective diameter among the object-side and sensor-side surfaces of the plurality of lenses, and means the largest effective diameter among the effective diameters (Unit: mm) of the first to sixteenth surfaces S1-S16. When Equation 38 is satisfied, the optical system 1000 may provide a slim and compact optical system while maintaining optical performance. Preferably, Equation 38 may satisfy: 2.5<CA_max/CA_min<5.

$$1 < CA\_max / CA\_AVR < 3 \qquad [ Equation 39 ]$$

In Equation 39, the maximum effective diameter CA_max and the average effective diameter CA_AVR of the object side and sensor side of the plurality of lenses are set, and when these are satisfied, a slim and compact optical system may be provided. Preferably, Equation 39 may satisfy: 1.5<CA_max/CA_AVR<2.5.

$$0.1 < CA\_min / CA\_AVR < 1 \qquad [ Equation 40 ]$$

In Equation 40, the smallest effective diameter CA_min and the average effective diameter CA_AVR of the object-side and the sensor-side surfaces of the plurality of lenses may be set, and when these are satisfied, a slim and compact optical system may be provided. Preferably, Equation 40 may satisfy: 0.1<CA_min/CA_AVR≤0.8.

$$0.1 < CA\_max / ( 2 \times ImgH ) < 1 \qquad [ Equation 41 ]$$

In Equation 41, the largest effective diameter CA_max among the object-side and sensor-side surfaces of the plurality of lenses and the distance ImgH from the center (0.0F) to the diagonal end (1.0F) of the image sensor 300 are set. When this is satisfied, the optical system 1000 has good optical performance in the center and periphery portions of the FOV, and may provide a slim and compact optical system. Here, ImgH may be in the range of 4 mm to 15 mm or 6 mm to 12 mm. Preferably, Equation 41 may satisfy: 0.5≤CA_max/(2+ImgH)<1.

$$0.1 < TD / CA\_max < 1.5 \qquad [ Equation 42 ]$$

In Equation 42, TD is the maximum optical axis distance from the object-side surface of the first lens group LG1 to the sensor-side surface of the second lens group LG2. For example, TD is the distance from the first surface S1 of the first lens 101 to the sixteenth surface S16 of the eighth lens 108 on the optical axis OA. When Equation 42 is satisfied, a slim and compact optical system may be provided. Preferably, Equation 42 may satisfy: 0.1<TD/CA_max<0.8.

$$0 < F / \vert L 8 R 2 \vert < 5 \qquad [ Equation 43 ]$$

In Equation 43, the total effective focal length F of the optical system 1000 and the curvature radius L8R2 of the sixteenth surface S16 of the eighth lens 108 may be set, and when these are satisfied, a size of the optical system 1000, for example, the TTL may be reduced. Preferably, Equation 43 may satisfy: 0<F/|L8R2|<1.

Equation 43 may further include Equations 43-1 and 43-2 below.

$$2 < F / F \# < 8 \qquad [ Equation 43 - 1 ]$$

The F # may mean an F number. Preferably, Equation 43-1 may satisfy: 2<F/F #<5.

$$0.5 < F / \vert L 7 R 2 \vert < 1. 5 \qquad [ Equation 43 - 2 ]$$

Equation 43-2 may set the total effective focal length F of the optical system 1000 and the curvature radius L7R2 of the fourteenth surface S14 of the seventh lens 107. Preferably, Equation 43-2 may satisfy 0.7<F/L7R2|<1.2.

$$0 < F / L 1 R 1 < 1 \qquad [ Equation 44 ]$$

In Equation 44, the curvature radius L1R1 and the total effective focal length F of the first surface S1 of the first lens 101 may be set, and when they are satisfied, a size of the optical system 1000, for example, TTL may be reduced. Preferably, Equation 44 may satisfy: 0<F/L1R1<0.55.

$$0 < EPD / \vert L 8 R 2 \vert < 5 \qquad [ Equation 45 ]$$

In Equation 45, EPD means the size (unit: mm) of the entrance pupil diameter of the optical system 1000, and L8R2 means the curvature radius (unit: mm) of the sixteenth surface S16 of the eighth lens 108. When the optical system 1000 according to the embodiment satisfies Equation 45, the optical system 1000 may control overall brightness and may have good optical performance in the center and periphery portions of the FOV. Preferably, Equation 45 may satisfy: 1<EPD/|L8R2|<1.

Equation 45 may further include Equation 45-1 below.

$$1 < EPD / F \# < 3 \qquad [ Equation 45 - 1 ]$$

Here, since the F number (F #) is set to 1.6 or more, a bright image may be provided.

$$0.5 < EPD / L 1 R 1 < 8 \qquad [ Equation 46 ]$$

Equation 46 means the relationship between the size of the entrance pupil diameter of the optical system and the curvature radius of the first surface S1 of the first lens 101, and may control incident light. Preferably, Equation 46 may satisfy: 1<EPD/L1R1<2.

$$- 5 < F 1 / F 2 < 0 \qquad [ Equation 47 ]$$

In Equation 47, the focal lengths F1 and F2 of the first and second lenses 101 and 102 may be set. Accordingly, resolving power may be improved by adjusting the refractive power of the incident light of the first and second lenses 101 and 102, and TTL may be controlled. Preferably, Equation 47 may satisfy: −1<F1/F2<0, and may satisfy the conditions: F1>0 and F2<0.

$$1 < F 12 / F < 5 \qquad [ Equation 48 ]$$

In Equation 48, by setting the composite length F12 of the first to second lenses and the total focal length F, the optical system 1000 may improve resolution by adjusting the refractive power of incident light, and may control the TTL of the optical system 1000. Preferably, Equation 48 may satisfy: 1<F12/F<1.5.

$$0.5 < F 13 / F < 1.5 \qquad [ Equation 48 - 1 ]$$

in Equation 48-1, by setting the composite length F13 of the first to third lenses and the total focal length F, the optical system 1000 may improve resolution by adjusting the refractive power of incident light, and may control the TTL of the optical system 1000. Preferably, Equation 48 may satisfy: 0.8<F13/F<1.2.

$$0 < \vert F 48 / F 13 \vert < 2 \qquad [ Equation 49 ]$$

In Equation 49, the composite focal length F13 of the first to third lenses and the composite focal length F48 of the fourth to eighth lenses may be set, and when these are satisfied, resolution may be improved by controlling the refractive power of the first lens group and the refractive power of the second lens group, and the optical system may be provided in a slim and compact size. In addition, when Equation 49 is satisfied, the optical system 1000 may improve aberration characteristics such as chromatic aberration and distortion aberration. The Equation 49 may preferably satisfy: 0.5<|F48/F13|<1. Here, the conditions may satisfy: F13>0 and F48<0.

$$0 < F 1 / F < 3 \qquad [ Equation 50 ]$$

In Equation 50, the total focal length F and the focal length of the first lens 101 may be set, and resolution may be improved. Equation 50 may satisfy: 0<F1/F<2, and satisfy the conditions: F>0 and 0<|F−F1|<5.

$$- 5 < F 2 / F < 0 ( where F 2 < 0 ) \qquad [ Equation 50 - 1 ]$$

$$0 < \vert F 3 / F 2 \vert < 2 ( where F 3 > 0 ) \qquad [ Equation 50 - 2 ]$$

$$- 15 < F 4 / F < 0 ( where F 4 < 0 ) \qquad [ Equation 50 - 3 ]$$

$$1 < F 5 / F < 5 ( where F 5 > 0 ) \qquad [ Equation 50 - 4 ]$$

$$2 < \vert F 6 \vert / F < 7 ( where F 6 < 0 ) \qquad [ Equation 50 - 5 ]$$

$$0 < F 7 / F < 2 ( where F 7 > 0 ) \qquad [ Equation 50 - 6 ]$$

$$1 < \vert F 8 \vert / F < 5 ( where F 8 < 0 ) \qquad [ Equation 50 - 7 ]$$

In Equations 50-1 to 50-7, F3, F4, F5, F6, F7, and F8 means the focal length (unit: mm) of the third, fourth, fifth, sixth, seventh, and eighth lenses 103, 104, 105, 106, 107, and 108, and when this is satisfied, the resolving power may be improved by controlling the refractive power of each lens, and the optical system may be provided in a slim and compact size.

Here, F1 is 6 mm or more, for example, in the range of 6 mm to 10 mm. F2 is-17 mm or less, for example, in the range of −17 mm to −27 mm. F3 is 16 mm or more, for example, in the range of 16 mm to 25 mm. F4 is-56 mm or less, for example, in the range of −56 mm to −85 mm. F5 is 17 mm or more, for example, in the range of 17 mm to 26 mm. F6 is-33 mm or less, for example, in the range of −33 mm to −50 mm. F7 is 7 mm or more, for example, in the range of −7 mm to −11 mm. F8 is −1 mm or more, for example, in the range of 1 mm to 3 mm. The sum of the focal lengths of the second, third, fifth, sixth, seventh, eighth, and ninth lenses may be 0 mm or less, for example, in the range of −15 mm to 0 mm, and when this is satisfied, the balance of the focal lengths may be adjusted.

$$0 < F 1 / F 13 < 2 \qquad [ Equation 51 ]$$

In Equation 51, the resolution of the first lens group may be adjusted by setting the focal length F1 of the first lens and the composite focal length F13 of the first to third lenses. Preferably, Equation 51 may satisfy: 0.5<F1/F13<1.5.

$$0 < F 1 / \vert F 48 \vert < 2 \qquad [ Equation 52 ]$$

In Equation 52, the size and resolution of the optical system may be adjusted by setting the focal length F1 of the first lens and the composite length F48 of the fourth to eighth lenses. Preferably, Equation 52 may satisfy: 1<F1/|F48|<2.

$$0 < \vert F 1 / F 4 \vert < 1 \qquad [ Equation 53 ]$$

In Equation 53, by setting the focal length F1 of the first lens and the focal length F4 of the fourth lens, the refractive power of light incident to the first and second lens groups may be controlled, and the size and resolution of the optical system may be adjusted. Preferably, Equation 53 may satisfy: 0<|F1/F4|<0.5.

$$2 mm < TTL < 20 mm \qquad [ Equation 54 ]$$

In Equation 54, TTL means the distance (unit: mm) in the optical axis OA from the apex of the first surface S1 of the first lens 101 to the image surface of the image sensor 300. Preferably, Equation 54 may satisfy: 5 mm<TTL<15 mm, and thus a slim and compact optical system may be provided.

$$2 mm < ImgH < 20 mm \qquad [ Equation 55 ]$$

Equation 55 sets the diagonal size (2*ImgH) of the image sensor 300 to exceed 4 mm, thereby providing an optical system with high resolution. Equation 55 may preferably satisfy: 4 mm≤ImgH≤15 mm or 6 mm≤ImgH≤12 mm.

Equation 55 may include at least one of Equations 55-1 to 55-4 below.

$$1.5 < ImgH / \sum CT / < 3 \qquad [ Equation 55 - 1 ]$$

$$1 < IMgH / \sum CG / < 3 \qquad [ Equation 55 - 2 ]$$

$$0 < ImgH / \sum Index / < 1 \qquad [ Equation 55 - 3 ]$$

$$0 < ImgH / \sum Abbe / < 0.2 \qquad [ Equation 55 - 4 ]$$

Equations 55-1 to 55-4 may establish a relationship between ImgH and the sum of center thicknesses of all lenses, the sum of center distances between lenses, the sum of refractive indices of all lenses, and the sum of Abbe numbers of all lenses. Accordingly, the resolution and size of the optical system having an ImgH of 4 mm or 6 mm or more may be adjusted.

$$BFL < 2.5 mm \qquad [ Equation 56 ]$$

Equation 56 may secure an installation space of the filter 500 by making the BFL (Back focal length) less than 2.5 mm, improve assembly of components, and improve coupling reliability through the distance between the image sensor 300 and the last lens. Equation 56 may preferably satisfy: 0.8 mm<BFL<2 mm.

$$2 mm < F < 20 mm \qquad [ Equation 57 ]$$

In Equation 57, the total focal length F may be set according to the optical system, and may preferably satisfy: 5 mm<F<15 mm.

$$FOV < 120 degrees \qquad [ Equation 58 ]$$

In Equation 58, a FOV means a field of view of the optical system 1000, and the optical system of less than 120 degrees may be provided. The FOV may be greater than 70 degrees, for example, in the range of 70 degrees to 100 degrees.

$$0.1 < TTL / CA\_max < 2 \qquad [ Equation 59 ]$$

In Equation 59, a slim and compact optical system may be provided by setting the largest effective diameter CA_max among the object-side and sensor-side surfaces of the plurality of lenses and TTL. Preferably, Equation 59 may satisfy: 0.3<TTL/CA_max<1.

$$0.5 < TTL / ImgH < 3 \qquad [ Equation 60 ]$$

Equation 60 may set the total optical axis length TTL of the optical system and the diagonal length ImgH with respect to the optical axis of the image sensor 300. When the optical system 1000 according to the embodiment satisfies Equation 60, the optical system 1000 secures a BFL for the application of a relatively large-sized image sensor 300, for example, a large-sized image sensor 300 around 1 inch, and may have a smaller TTL and may have a high-definition implementation and a slim structure. Preferably, Equation 60 may satisfy: 0.8<TTL/ImgH<2. Preferably, the condition may satisfy: 50<TTL*ImgH<90.

$$0 < BFL / ImgH < 0.5 \qquad [ Equation 61 ]$$

Equation 61 may set the distance in the optical axis between the image sensor 300 and the last lens and the length in the diagonal direction from the optical axis in the image sensor 300. When the optical system 1000 according to the embodiment satisfies Equation 61, the optical system 1000 may secure a BFL for applying a relatively large image sensor 300, for example, a large image sensor 300 of around 1 inch, and minimize the distance between the last lens and the image sensor 300, thereby having good optical characteristics at the center and periphery portion of the FOV. Preferably, Equation 61 may satisfy: 0≤BFL/ImgH≤0.3.

$$4 < TTL / BFL < 10 \qquad [ Equation 62 ]$$

Equation 62 may set (unit: mm) the total optical axis length TTL of the optical system and the optical axis distance BFL between the image sensor 300 and the last lens. When the optical system 1000 according to the embodiment satisfies Equation 62, the optical system 1000 secures the BFL and may be provided slim and compact. Equation 62 may satisfy: 6<TTL/BFL<10.

$$0.5 < F / TTL < 1.5 \qquad [ Equation 63 ]$$

Equation 63 may set the total focal length F and total optical axis length TTL of the optical system 1000. Accordingly, a slim and compact optical system may be provided. Equation 63 may preferably satisfy: 0.5<F/TTL<1.2.

$$0 < F \# / TTL < 0.5 \qquad [ Equation 63 - 1 ]$$

Equation 63-1 may set the F number F # and the total optical axis length TTL of the optical system 1000. Accordingly, a slim and compact optical system may be provided.

$$3 < F / BFL < 10 \qquad [ Equation 64 ]$$

Equation 64 may set the total focal length F of the optical system 1000 and the optical axis distance BFL between the image sensor 300 and the last lens. When the optical system 1000 according to the embodiment satisfies Equation 64, the optical system 1000 may have a set FOV, may have an appropriate focal length, and may provide a slim and compact optical system. In addition, the optical system 1000 may minimize the distance between the last lens and the image sensor 300, so that it may have good optical characteristics in the periphery portion of the FOV. Preferably, Equation 64 may satisfy: 5<F/BFL<9.

$$0 < F / ImgH < 3 \qquad [ Equation 65 ]$$

Equation 65 may set the total focal length F of the optical system 1000 and the diagonal length ImgH from the optical axis of the image sensor 300. The optical system 1000 may have improved aberration characteristics by applying a relatively large image sensor 300, for example, a large image sensor 300 of around 1 inch. Preferably, Equation 65 may satisfy: 0.8≤F/ImgH<1.5.

$$1 < F / EPD < 5 \qquad [ Equation 66 ]$$

Equation 66 may set the total focal length F and entrance pupil diameter (EPD) of the optical system 1000. Accordingly, the overall brightness of the optical system may be controlled. Preferably, Equation 66 may satisfy: 1.5≤F/EPD<3.

$$0 < BFL / TD < 0.3 \qquad [ Equation 67 ]$$

In Equation 67, the optical axis distance BFL between the image sensor 300 and the last lens and the optical axis distance TD of the lenses are set, and when these are satisfied, the optical system 1000 may provide a slim and compact optical system. Preferably, Equation 67 may satisfy: 0<BFL/TD≤0.2. When BFL/TD exceeds 0.3, the size of the entire optical system increases because the BFL compared to TD is designed to be large, which makes it difficult to miniaturize the optical system, and since the distance between the eleventh lens and the image sensor increases, the amount of unnecessary light may increase through the eleventh lens and the image sensor, and as a result, there is problem in that resolving power is lowed, such as deterioration in aberration characteristics.

$$0 < EPD / ImgH / FOV < 0.2 \qquad [ Equation 68 ]$$

In Equation 68, the relationship between the size of the entrance pupil diameter EPD, the length (ImgH) of ½ of the maximum diagonal length of the image sensor, and the FOV may be set. Accordingly, the overall size and brightness of the optical system may be controlled. Equation 68 may preferably satisfy: 0<EPD/ImgH/FOV<0.1.

$$10 < FOV / F \# < 55 \qquad [ Equation 69 ]$$

Equation 69 may establish a relationship between the FOV of the optical system and the F number. Equation 69 may preferably satisfy: 30<FOV/F #<50.

$$0 < n 1 / n 2 < 1.5 \qquad [ Equation 70 ]$$

When the refractive indices n1 and n2 of the first and second lenses 101 and 102 of Equation 70 at the d-line satisfy the above range, the optical system may improve the resolution of the incident light. Preferably, it may satisfy: 0.5<n1/n2≤1.

$$0 < n 3 / n 4 < 1.5 \qquad [ Equation 71 ]$$

When the refractive indices n3 and n4 of the third and fourth lenses 103 and 104 of Equation 71 at the d-line satisfy the above range, the optical system may improve resolution of the incident light of the second lens group LG2. Preferably, Equation 71 may satisfy: 0.5<n3/n4≤1.

$$0.5 < Inf 71 / Inf 72 < 2 \qquad [ Equation 72 ]$$

In Equation 72, the distance Inf71 from the optical axis OA to the critical point of the object-side surface of the seventh lens 106 and the distance Inf72 from the sensor-side surface S12 to the critical point may be set. A satisfactory aberration of the sixth lens may be controlled. Equation 72 may satisfy: 0.5<Inf71/Inf72<1.5.

$$0.5 < Inf 71 / Inf 82 < 1.5 \qquad [ Equation 73 ]$$

In Equation 73, the distance Inf71 from the optical axis OA to the critical point of the object-side surface of the seventh lens 107 and the distance Inf82 to the critical point of the sensor-side surface of the eighth lens 108 may be set, when this is satisfied, the satisfactory aberration of the eighth lens may be controlled. Equation 73 may satisfy: 1<Inf71/Inf82<1.5.

$$1 < Inf 72 / Inf 82 < 5 \qquad [ Equation 74 ]$$

In Equation 74, the distance Inf72 from the optical axis OA to the critical point of the sensor-side surface S14 of the seventh lens 107 and the distance Inf82 to the critical point of the sensor-side surface of the eighth lens 108 may be set, and when this is satisfied, the satisfactory aberration of the seventh and eighth lenses may be controlled. Equation 74 may satisfy: 1<Inf72/Inf82<2.

$$5 < ( TTL / ImgH ) * n < 15 \qquad [ Equation 75 ]$$

Preferably, Equation 79 may satisfy: 6< (TTL/ImgH)*n<10.

$$4 < ( F / ImgH ) * n < 14 \qquad [ Equation 76 ]$$

$$Preferably , Equation 80 may satisfy : 6 < ( F / ImgH ) * n < 11.$$

$$10 < ( TD\_LG2 / TD\_LG1 ) * n < 35 \qquad [ Equation 77 ]$$

$$10 < ( CT\_Max + CG\_Max ) * n < 20 \qquad [ Equation 78 ]$$

$$40 < ( FOV * TTL ) / n < 120 \qquad [ Equation 79 ]$$

$$( TTL * n ) > FOV \qquad [ Equation 80 ]$$

$$( v 2 * n 2 ) < ( v 1 * n 1 ) \qquad [ Equation 81 ]$$

In Equations 75 to 81, n is the total number of lenses, and relationship between the optical axis distance TD_LG1 of the first lens group LG1, the optical axis distance TD_LG2 of the second lens group LG2, the maximum center thickness CT_Max of the lenses, the maximum center distance CG_max, FOV, TTL, and like may set according to the total number of lenses. Accordingly, it is possible to control chromatic aberration, resolving power, size, and the like of an optical system having 9 or less lenses.

$$0 \leq \vert Fx - Fy \vert \leq 0.1 \qquad [ Equation 82 ]$$

$$F 7 x \neq F 7 y \qquad [ Equation 83 ]$$

$$F 8 x \neq F 8 y \qquad [ Equation 84 ]$$

$$Fx / Fy < F 7 x / F 7 y \qquad [ Equation 85 ]$$

In Equations 82 to 85, since the object-side surface or/and sensor-side surface of the seventh and eighth lenses have freeform surfaces, the focal lengths of the seventh and eighth lenses may be set differently according to different directions. Accordingly, it is possible to reduce a difference in the amount of incident light at the periphery portion of the image sensor 300.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + ⋯ \qquad [ Equation 86 ]$$

In Equation 86, Z is Sag and may mean a distance in the optical axis direction from an arbitrary position on the aspheric surface to the apex of the aspheric surface. The Y may mean a distance in a direction perpendicular to the optical axis from an arbitrary position on the aspheric surface to the optical axis. The c may mean the curvature of the lens, and K may mean the conic constant. Also, A, B, C, D, E, and F may mean aspheric constants.

$$\tilde{z} ( \tilde{x} , \tilde{y} ) = {z}_{base} ( \tilde{x} , \tilde{y} ) + \frac{δ ( \tilde{u} , \tilde{θ} )}{σ ( \tilde{r} )} \qquad [ Equation 87 ]$$

Equation 87 is a coefficient for freeform surfaces of the object-side surface and the sensor-side surface of the seventh and eighth lenses 107 and 108, and may be expressed as an 80th order coefficient as shown in FIGS. 4b and 9b as an SPS Q2D surface equation. Here, a variable with a tilde (˜) represents a parameter of an off-axis coordinate system.

The optical system 1000 according to the embodiment may satisfy at least one or two or more of Equations 1 to 85. In this case, the optical system 1000 may have improved optical characteristics. In detail, when the optical system 1000 satisfies at least one or two or more of Equations 1 to 85, the optical system 1000 has improved resolution and may improve aberration and distortion characteristics. In addition, the optical system 1000 may secure a BFL for applying the large-size image sensor 300, and may minimize the distance between the last lens and the image sensor 300 and thus have good optical performance in the center and periphery portions of the FOV. In addition, when the optical system 1000 satisfies at least one of Equations 1 to 85, it may include a relatively large image sensor 300, have a relatively small TTL value, and may provide a slimmer and more compact optical system and a camera module having the same.

In the optical system 1000 according to the embodiment, the distance between the plurality of lenses 100 may have a value set according to the region.

FIGS. 3 and 8 are examples of lens data according to an embodiment having the optical system of FIG. 1.

As shown in FIG. 3, the optical system according to the embodiment represents the curvature radius of the first to eighth lenses 101 to 108 on the optical axis OA, the center thickness CT of the lens, and the center distances CG between the lenses, refractive index at d-line (588 nm), Abbe number and effective radius (Semi-aperture), and focal length.

The sum of the refractive indices of the plurality of lenses is greater than 10, the Abbe sum is 300 or more, and the sum of center thicknesses of all lenses is 5 mm or less, for example, in the range of 2 mm to 5 mm. A sum of center distances between the first to eighth lenses on the optical axis may be 6 mm or less, for example, in a range of 2 mm to 6 mm, and may be smaller than the sum of center thicknesses of the lenses. In addition, the average value of the effective diameter of each lens surface of the plurality of lenses 100 is 8 mm or less, for example, in the range of 3 mm to 8 mm. The average of the center thickness of each lens may be less than 1 mm, for example, in the range of 0.2 mm to 0.7 mm. The sum of the effective diameters of each lens surface of the plurality of lenses 100 is the sum of the effective diameters from the first surface S1 to the sixteenth surface S16, and may be less than 150 mm, for example, in the range of 80 mm to 150 mm.

As shown in FIGS. 4a and 9a, in an embodiment, at least one or all lens surfaces of a plurality of lenses may include an aspherical surface having a 30th order aspherical surface coefficient. For example, the first to eighth lenses 101 to 108 may include lens surfaces having 30th order aspheric coefficients from the first surface S1 to the sixteenth surface S16. As described above, an aspherical surface having a 30th order aspherical surface coefficient (a value other than “0”) may change the aspheric shape of the periphery particularly greatly, so that the optical performance of the periphery portion of the FOV may be well corrected. As shown in FIGS. 4b and 9b, the seventh and eighth lenses may represent a freeform surface having an 80th order coefficient, and may further improve optical performance of the periphery portion of the FOV.

As shown in FIGS. Sa and 10b, the first to eighth thicknesses T1 to T8 of the first to eighth lenses 101 to 108 may be represented at distances of 0.1 mm or more in the direction Y from the center to the edge of each lens, and the distance between adjacent lenses may be expressed at distances of 0.1 mm or more in a direction from the center to the edge with respect to a first distance G1 between the first and second lenses, a second distance G2 between the second and third lenses, a third distance G3 between the third and fourth lenses, a fourth distance G4 between the fourth and fifth lenses, a fifth distance G5 between the fifth and sixth lenses, a sixth distance G6 between the sixth and seventh lenses, and a seventh distance G7 between the seventh and eighth lenses.

The maximum thickness of the first thickness T1 may be 1.1 times or more, for example, in a range of 1.1 to 4 times the minimum thickness. The maximum distance of the first distance G1 may be 1.1 times or more, for example, in a range of 1.1 to 2.5 times the difference between the minimum distance. The maximum thickness of the second thickness T2 may be 1.1 times or more, for example, in a range of 1.1 to 2.5 times the minimum thickness. The maximum distance of the second distance G2 may be 1.1 times or more, for example, in a range of 1.1 to 3 times the minimum distance. The maximum thickness of the third thickness T3 may be 1.1 times or more, for example, in a range of 1.1 to 3 times the minimum thickness. The maximum distance of the third distance G3 may be 0.8 times or more, for example, in a range of 0.8 to 2.5 times the difference between the minimum distance. The maximum thickness of the fourth thickness T4 may be 0.5 times or more, for example, in a range of 0.5 to 2 times the minimum thickness. The maximum distance of the fourth distance G4 may be 1.1 times or more, for example, in a range of 1.1 to 2.5 times the minimum distance. The maximum thickness of the fifth thickness T5 may be 1.1 times or more, for example, in a range of 1 to 3 times the minimum thickness. The maximum distance of the fifth distance G5 may be 1.1 times or more, for example, in a range of 1.1 to 2.5 times the minimum distance. The maximum thickness of the sixth thickness T6 may be 1.5 times or more, for example, in a range of 1.5 to 5 times the minimum thickness. The maximum distance of the sixth distance G6 may be one or more times, for example, in a range of 1 to 3 times the minimum distance. The maximum thickness of the seventh thickness T7 may be one or more times the minimum thickness, for example, in a range of 1 to 2.5 times. The maximum distance of the seventh distance G7 may be 3 times or more, for example, in a range of 3 to 12 times the minimum distance. The maximum thickness of the eighth thickness T8 may be twice or more, for example, in a range of 2 to 7 times the minimum thickness. The optical system may be provided in a slim and compact size by using the first to eighth thicknesses T1 to T8 and the first to seventh distances G1 to G7.

As shown in FIGS. 5b, 5c, 10b, and 10c, a first direction X orthogonal to the optical axis OA and a second direction Y orthogonal to the optical axis OA and the first direction X may be defined. The first direction X is 0 degree as reference, the second direction Y is 90 degrees, and it may be divided into 30 degrees, 45 degrees, 53 degrees, and 60 degrees from the first direction X toward the second direction Y. In the drawing, Y (unit: mm) represents a height direction orthogonal to the optical axis, and is data measured at distances of 0.1 mm or more.

As shown in FIGS. 5b and 10b, the sixth distance G6 represents the distance between the sensor-side surface of the sixth lens 106 and the object-side surface of the seventh lens 107. The sixth distance G6 may vary depending on the freeform surface of the object-side surface of the seventh lens 107. For example, the sixth distance G6 is spaced apart along directions of 0, 30, 45, 53, 60, and 90 degrees, has the same distance in the optical axis OA, and may have different distances at it is closer to end (e.g., 3.6 mm) of the effective region.

The seventh thickness T7 is a straight distance between the object-side surface and the sensor-side surface of the seventh lens 107, and may be changed by the freeform surface of the object-side surface and the sensor-side surface of the seventh lens 107 from the optical axis OA to the end of the effective region. For example, the seventh thickness T7 may have the same thickness from the optical axis OA along directions of 0, 30, 45, 53, 60, and 90 degrees, respectively, and may have different thickness as it is closer to the end (e.g., 4.2 mm) of the effective region.

As shown in FIGS. 5c and 10c, the seventh distance G7 represents the distance between the sensor-side surface of the seventh lens 107 and the object-side surface of the eighth lens 108. The seventh distance G7 may be changed by a freeform surface of the sensor-side surface of the seventh lens 107 and a freeform surface of the object-side surface of the eighth lens 108. For example, the seventh distance G7 is spaced apart along directions of 0, 30, 45, 53, 60, and 90 degrees, has the same distance on the optical axis OA, and may have different distance at it is closer to the end (e.g., 4.6 mm) of an effective region.

The eighth thickness T8 is a straight distance between the object-side surface and the sensor-side surface of the eighth lens 108, and may be changed by the freeform surface of the object-side surface and the sensor-side surface of the eighth lens 108 from the optical axis OA to the end of the effective region. For example, the eighth thickness T8 may have the same thickness on the optical axis OA along directions of 0, 30, 45, 53, 60, and 90 degrees, respectively, and may have different thickness as it is closer to the end (e.g., 5.5 mm) of the effective region.

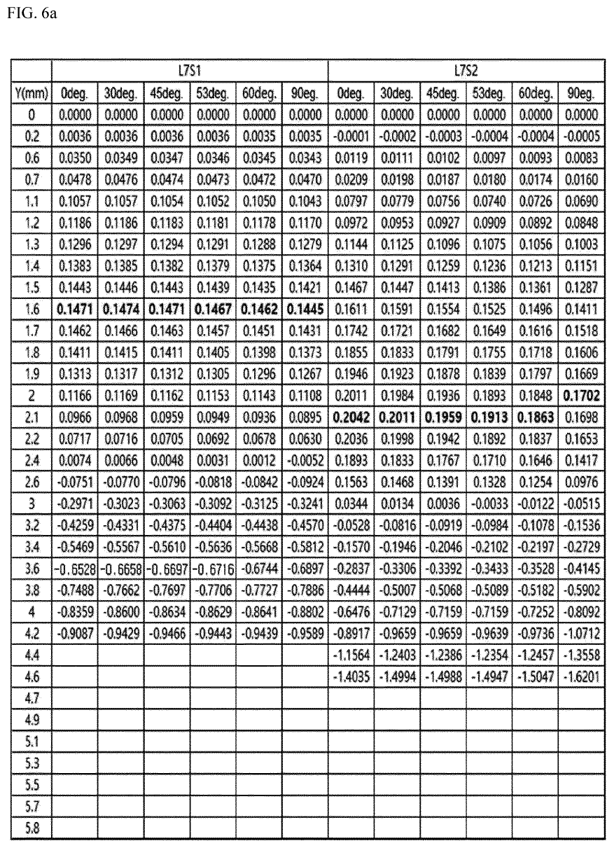

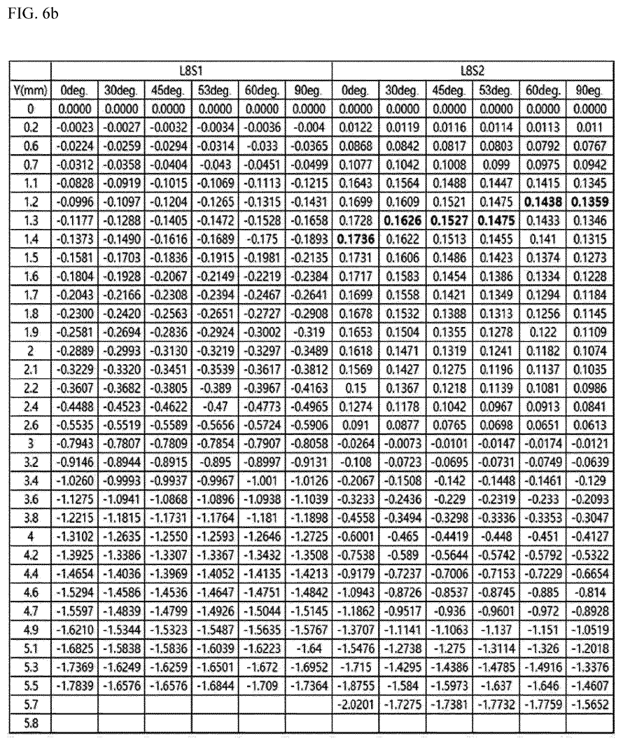

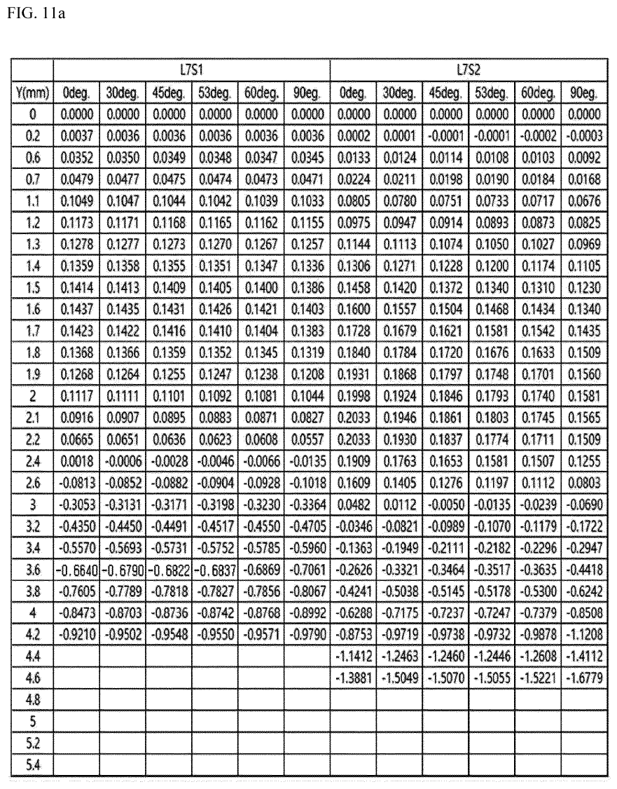

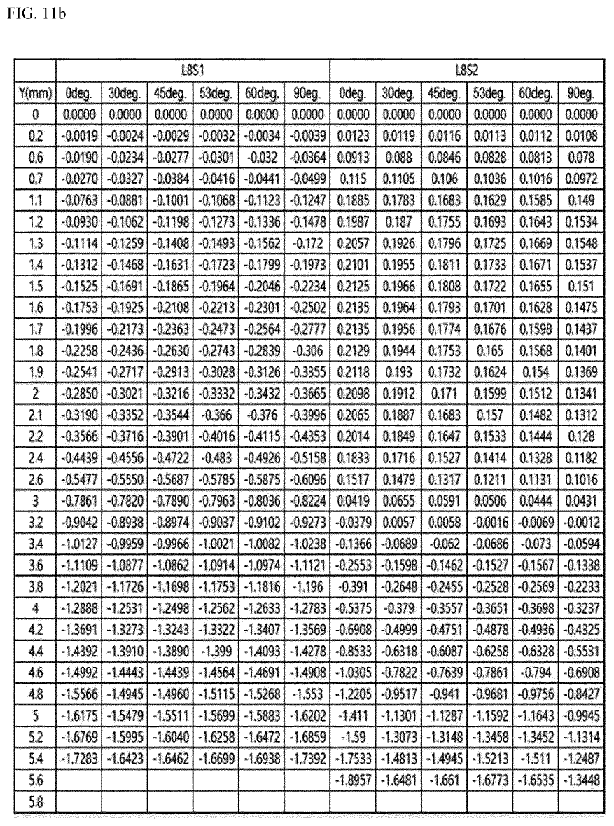

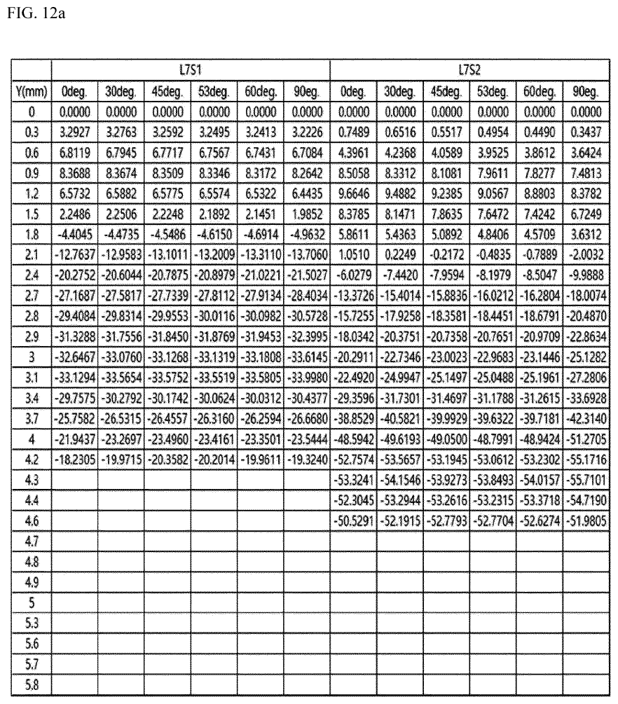

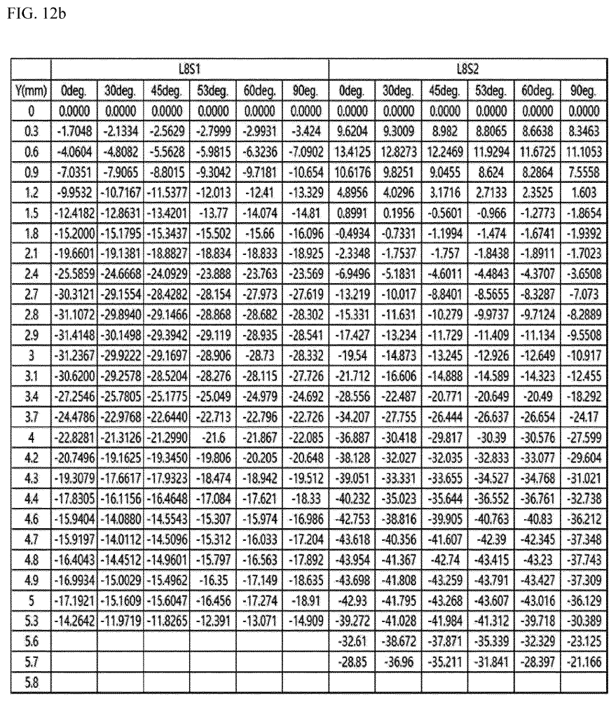

As shown in FIGS. 6a, 6b, 11a, and 11b, the object-side surface L7S1 and sensor-side surface L7S2 of the seventh lens, and the object-side surface L8S1 and sensor-side surface L8S2 of the eighth lens represents the Sag value. Here, the Sag value is the height of each lens surface based on a straight line orthogonal to the center (e.g., optical axis) of each lens surface L7S1, L7S2, L8S1, and L8S2, and when it is located closer to the sensor side than the straight line, it is positive +, and when it is located closer to the object side that the straight line, it may have a negative (−) value.

As shown in FIGS. 6a and 11a, it may be seen that the object-side surface L7S1 of the seventh lens has the critical points around 1.6 mm at 0, 30, 45, 53, 60, and 90 degrees, respectively, and the sensor-side surface L7S2 has different critical point positions at 0, 30, 45, 53, 60, and 90 degrees, respectively, at 1.8 mm to 2.3 mm.

As shown in FIGS. 6b and 11b, since the object-side surface L8S1 of the eighth lens gradually decreases from the optical axis to the end of the effective region at 0, 30, 45, 53, 60, and 90 degrees, respectively, there is no critical point and it may be seen that the sensor-side surface L8S2 has different critical point positions at 0, 30, 45, 53, 60, and 90 degrees at 0.8 mm to 1.8 mm, respectively.

It is preferable that the positions of the critical points P1, P2, and P3 of the seventh and eighth lenses 107 and 108 are disposed at positions satisfying the aforementioned range in consideration of the optical characteristics of the optical system 1000. In detail, the location of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

In the center thicknesses CT7 and CT8 and the sixth and seventh distances G6 and G7 of the seventh and eighth lenses 107 and 108 may be provided as freeform surfaces at least one or both of the object-side surface and the sensor-side surface. For example, the thirteenth and fourteenth surfaces S13 and S14 of the seventh lens 107 are freeform surfaces and have a symmetrical shape (+X, −X) in a first direction X orthogonal to the optical axis OA with respect to the optical axis OA, have a symmetrical shape (+Y, −Y) in a second direction Y orthogonal to the optical axis OA, and have asymmetrical shapes in the first and second directions X and Y orthogonal to each other with respect to the optical axis OA.

The lens surfaces of +Y and −Y directions are symmetrical to both sides of the second direction Y with respect to the XZ plane or the optical axis OA, and the lens surfaces of +X and −X directions are symmetrical to both sides of the first direction X with respect to the YZ plane or the optical axis OA. Here, the Z-axis direction is the optical axis direction. Each of the thirteenth and fourteenth surfaces S13 and S14 and the fifteenth and sixteenth surfaces S15 and S16 in the first direction X and the second direction Y may have an asymmetric shape in different directions from each other with respect to the optical axis OA.

The seventh and eighth thicknesses T7 and T8 of the seventh and eighth lenses 107 and 108 may include regions having different thicknesses at positions spaced apart from each other by the same distance based on the optical axis OA in the first and second directions or in different directions.

In addition, the sixth and seventh distances G6 and G7 may include regions with different distances at positions spaced at the same distance based on the optical axis OA in the first and second directions or in different directions.

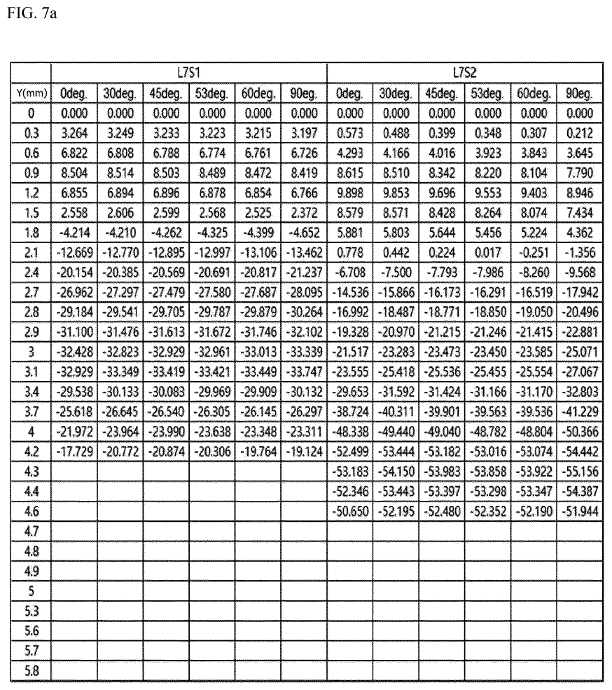

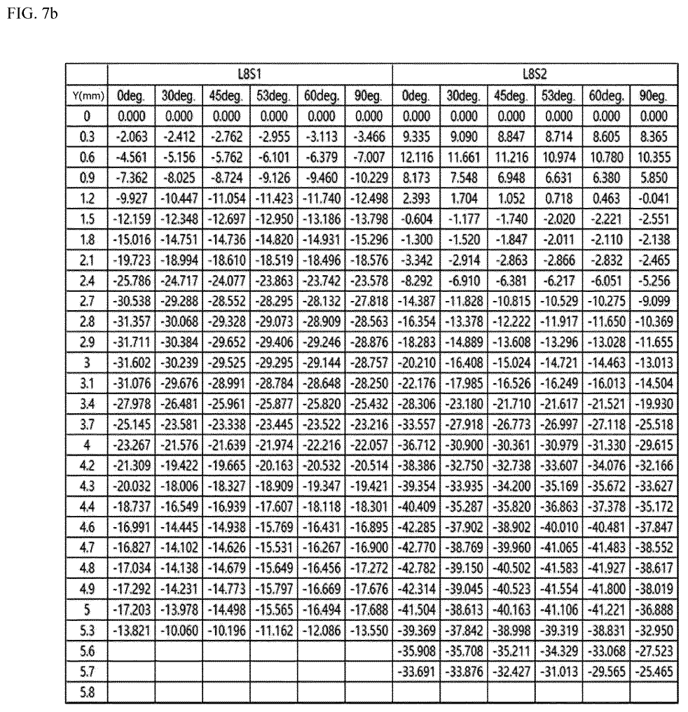

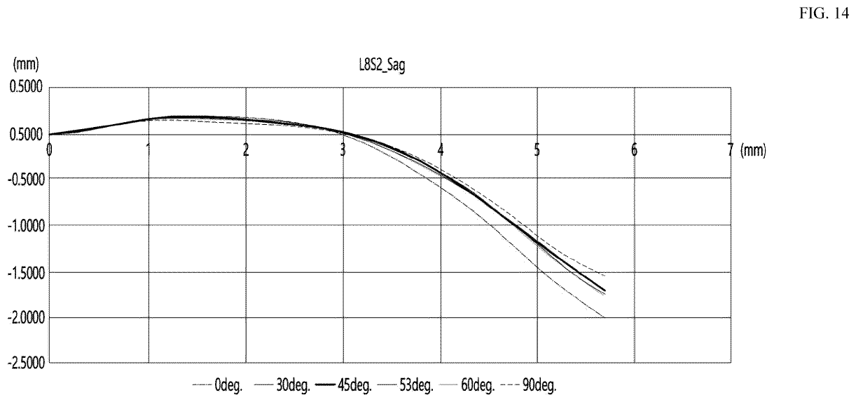

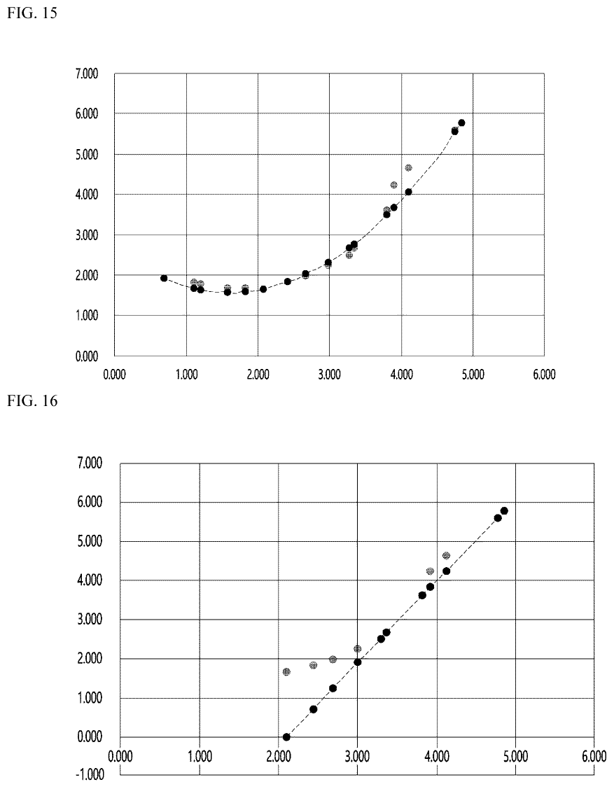

In FIGS. 6a, 6b, 7a, and 7b, it is expressed as the height (Sag value) from the straight line in the Y-axis direction perpendicular to the centers of the object-side surface L7S1 and the sensor-side surface L7S2 of a seventh lens 107 and the object-side surface L8S1 and the sensor-side surface L8S2 of the eighth lens 108 according to an embodiment of the invention to the lens surface at distances of 0.1 mm or more, and FIGS. 14 and 15 are graphs showing the sensor-side surface L7S2 of the seventh lens 107 and the sensor-side surface L8S2 of the eighth lens 108. As shown in FIG. 14, it may be seen that the critical point of L7S2 occurs along 0, 30, 45, 53, 60, and 90 degrees between 1.5 mm and 2.5 mm, and the graphs of 0, 30, 45, 53, and 90 degrees move more toward the object side than the 60-degree graph toward the end of the effective region. Here, moving toward the object side means that the lens surface in the other direction is inclined more toward the object side based on the 60-degree graph. As shown in FIG. 15, it may be seen that the critical point of L8S2 occurs along 0, 30, 45, 53, 60, and 90 degrees between 1 mm and 2 mm, and the graphs of 0, 30, 45, 53, and 90 degrees move more toward the object side than 90-degree graph toward the end of the effective region. Here, moving toward the object side means that the lens surface in the other direction is inclined more toward the object side based on the 90-degree graph.

It may be seen that the critical points P1 and P2 occur at 2.5 mm or less from the optical axis, and the Sag value of the object-side surface L7S1 protrudes toward the sensor side more than the Sag value of the sensor-side surface L7S2. And, in the sensor-side direction, the Sag value of L8S2, which is the sensor-side surface of the eighth lens 108, may be greater than the Sag value of the object-side surface L8S1, and as shown in FIGS. 2 and 11, the critical point P3 of the object-side surface of the eighth lens 108 may disposed closer to the optical axis than the other critical points P1, P2, and P4.

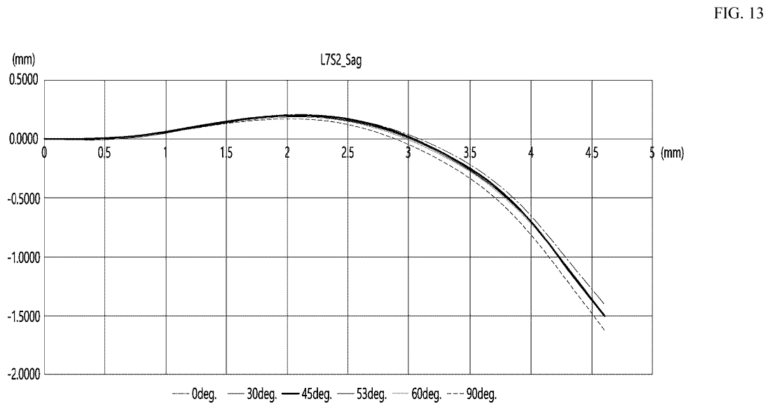

FIGS. 7a, 7b, 13a, and 13b are graphs showing the inclination angles of the object-side surfaces L7S1 and L8S1 and the sensor-side surfaces L7S2 and L8S2 of the seventh and eighth lenses, and may be obtained negative and positive angles according to the inclination direction. The inclination angle may be measured along each direction (0 degree, 30 degree, 45 degree, 53 degree, 60 degree, 90 degree), and it may be seen that it appears different from each other as it is closer to the end of the effective region from the optical axis. The maximum inclination angle of the object-side surface of the seventh lens may be 25 degrees or more, for example, in the range of 25 to 38 degrees, and the maximum inclination angle of the sensor-side surface may be greater than the maximum inclination angle of the object-side surface, and may be 50 degrees or more, for example, in the range of 50 to 60 degrees. The maximum inclination angle of the object-side surface of the eighth lens is 25 degrees or more, for example, in the range of 26 degrees to 36 degrees, and the maximum inclination angle of the sensor-side surface may be greater than the maximum inclination angle of the object-side surface, and may be 37 degrees or more, for example, in the range of 37 degrees to 47 degrees.

Here, the inclination angle or the maximum angle of the sensor-side surface L7S2 of the seventh lens may include regions having different angles at the same distance from the optical axis. Also, the inclination angle or the maximum angle of the object-side surface of the seventh lens may include regions having different angles at the same distance from the optical axis. An inclination angle or a maximum angle of the sensor-side surface L8S2 of the eighth lens may include regions having different angles at the same distance from the optical axis. Here, the inclination angle or the maximum angle of the sensor-side surface of the eighth lens may include regions having different angles at the same distance from the optical axis.

FIG. 15 shows a quadratic function closest to a curve passing through the ends of effective regions of the object-side surface and the sensor-side surface of each lens in the optical system according to the first and second embodiments, and which is a quadratic function that approximates a curve connection the end of the effective region of the object-side surface of the first lens to the end of the effective region of the sixteenth surface of the eighth lens, and may be obtained as y=0.4053x²−1.3135x+k1. The k1 is a constant for setting the position in the y-axis direction, and may be set to 2.6±0.1, and the fitting coefficient of the binary function may be 0.4±0.1.

FIG. 16 shows a linear function that approximates lines connecting the end of the effective region of the object-side surface of the fourth lens with the minimum effective diameter to the end of the effective region of the lens with the maximum effective diameter, which may satisfy the condition: y=2.0884x+k2, and the k2 may be set to 4.3±0.05 as a constant. At this time, the inclination angle of the linear function may be in the range of 50 degrees or more, for example, in the range of 50 degrees to 70 degrees with respect to the optical axis. As shown in FIGS. 15 and 16, it is possible to set a quadratic function connecting the ends of the effective region of each lens, and the linear function at the end of the effective region of the lens having the minimum effective diameter and the end of the effective region of the lens having the maximum effective diameter, optimally setting the size of the optical system.

Table 1 relates to the items of the above-mentioned equations in the optical system 1000 according to the embodiment, TTL, BFL, total effective focal length F value of the optical system 1000, ImgH, focal lengths F1, F2, F3, F4, F5, F6, F7, and F8 of each of the first to eighth lenses, edge thickness, edge distance, composite focal length, and the like.

TABLE 1

| Item | Embodiment 1 | Embodiment 2 |
|---|---|---|
| F | 7.573 | 7.588 |
| Fx | 7.563 | 7.578 |
| Fy | 7.583 | 7.598 |
| F1 | 7.858 | 7.238 |
| F2 | −22.479 | −16.472 |
| F3 | 20.216 | 20.472 |
| F4 | −71.172 | −118.732 |
| F5 | 21.765 | 23.976 |
| F6 | −41.653 | −56.517 |
| F7 | 8.784 | 9.230 |
| F7x | 9.141 | 9.673 |
| F7y | 8.427 | 8.786 |
| F8 | −2.438 | −2.500 |
| F8x | −2.487 | −2.555 |
| F8y | −2.389 | −2.446 |
| F13 | 7.595 | 7.791 |
| F48 | −4.883 | −5.277 |
| Fx48 | −4.913 | −5.302 |
| Fy48 | −4.854 | −5.252 |
| TTL | 7.930 | 7.930 |
| F# | 1.982 | 1.976 |
| ET1 | 0.417 | 0.350 |
| ET2 | 0.381 | 0.420 |
| ET3 | 0.251 | 0.249 |
| ET4 | 0.257 | 0.255 |
| ET5 | 0.291 | 0.286 |
| ET6 | 0.453 | 0.441 |
| ET7 | 0.301 | 0.301 |
| ET8 | 0.250 | 0.254 |
| EG1 | 0.088 | 0.088 |
| EG2 | 0.239 | 0.235 |
| EG3 | 0.340 | 0.303 |
| EG4 | 0.311 | 0.377 |
| EG5 | 0.077 | 0.077 |
| EG6 | 0.113 | 0.097 |
| EG7 | 0.684 | 0.671 |
| FOV | 90.000 | 90.000 |
| EPD | 3.820 | 3.840 |
| BFL | 1.016 | 1.034 |
| TD | 6.914 | 6.896 |
| ImgH | 7.935 | 7.935 |
| SD | 5.675 | 5.659 |

Table 2 shows the result values for Equations 1 to 42 described above in the optical system 1000 of FIG. 1. Referring to Table 2, it may be seen that the optical system 1000 satisfies at least one, two or more, or three or more of Equations 1 to 42. In detail, it may be seen that the optical system 1000 according to the embodiment satisfies all of Equations 1 to 42. Accordingly, the optical system 1000 may improve optical performance and optical characteristics at the center and the periphery portions of the FOV.

TABLE 2

| Equations | | Embodiment 1 | Embodiment 2 |
|---|---|---|---|
| 1 | 1 < CT1/CT2 < 5 | 3.101 | 3.091 |
| 2 | 0.5 < CT3/ET3 < 3 | 1.645 | 1.493 |
| 3 | 1 < ET8/CT8 < 4 | 0.715 | 0.727 |
| 4 | 1.60 < n2 | 1.696 | 1.696 |
| 5 | 0.5 < L8S2_max_sag to | 0.842 | 0.824 |
| | Sensor < 1.5 | | |
| 6 | 0.8 < BFL/L8S2_max_sag to | 1.206 | 1.255 |
| | Sensor < 2 | | |
| 7 | 5 < \|L8S2_max slope\| < 65 | 42.782 | 43.954 |
| 8 | 0.5 < Inf82 < 2 | 1.300 | 1.300 |
| 9 | 1 < CG7/G7_min < 20 | 9.783 | 11.213 |
| 10 | 0 < CG7/EG7 < 5 | 1.153 | 1.200 |
| 11 | 0 < CG1/CG7 < 1 | 0.063 | 0.062 |
| 12 | 0 < CT1/CT7 < 2 | 1.000 | 1.019 |
| 13 | 0 < CT6/CT7 < 3 | 0.333 | 0.341 |
| 14 | 0 < \|L7R2/L8R1\| < 2 | 0.775 | 0.780 |
| 15 | 0 < (CG7 − EG7)/(CG7) < 2 | 0.132 | 1.000 |
| 16 | 0.5 < CA11/CA22 < 2 | 1.151 | 1.153 |
| 17 | 1 < CA72/CA31 < 5 | 2.785 | 2.700 |
| 18 | 0.5 < CA32/CA41 < 2 | 0.901 | 0.922 |
| 19 | 0.1 < CA52/CA72 < 1 | 0.539 | 0.541 |
| 20 | 1 < CA82/CA11 < 5 | 3.025 | 3.003 |
| 21 | 0 < CG3/EG3 < 5 | 1.244 | 1.132 |
| 22 | 1 < CG6/EG6 < 5 | 2.649 | 0.447 |
| 23 | 0 < G7_max/CG7 < 2 | 1.172 | 1.232 |
| 24 | 0 < CT7/CG7 < 2 | 1.141 | 1.093 |
| 25 | 1 < CT7/CG6 < 3 | 2.016 | 2.050 |
| 26 | 0.1 < CT8/CG7 < 1 | 0.444 | 0.435 |
| 27 | 10 < L6R2/CT6 < 70 | 45.807 | 44.399 |
| 28 | 0 < \|L6R1/L8R1\| < 5 | 2.992 | 2.203 |
| 29 | 0 < L1R1/L1R2 < 1 | 0.378 | 0.293 |
| 30 | 0 < L2R2/L2R1 < 2 | 0.675 | 0.563 |
| 31 | 0 < CT_Max/CG_Max < 2 | 1.141 | 1.113 |
| 32 | 0.5 < ΣCT/ΣCG < 2 | 1.185 | 1.184 |
| 33 | 10 < ΣIndex < 30 | 12.759 | 12.740 |
| 34 | 10 < ΣAbbe/ΣIndex < 50 | 24.310 | 23.088 |
| 35 | FOV < (ΣIndex*nL) | Satisfaction | Satisfaction |
| 36 | 0 < EG_Max/CT_Max < 2 | 0.761 | 0.762 |
| 37 | 0.5 < CA11/CA_min < 2 | 1.158 | 1.153 |
| 38 | 1 < CA_max/CA_min < 5 | 3.502 | 3.464 |
| 39 | 1 < CA_max/CA_AVR < 3 | 2.024 | 2.020 |
| 40 | 0.1 < CA_min/CA_AVR < 1 | 0.578 | 0.583 |
| 41 | 0.1 < CA_max/(2*ImgH) < 1 | 0.728 | 0.727 |
| 42 | 0.1 < TD/CA_max < 1.5 | 0.598 | 0.688 |

Table 3 shows the result values for Equations 43 to 81 described above in the optical system 1000 of FIG. 1. Referring to Table 3, the optical system 1000 may satisfy at least one or two or more of Equations 1 to 42 and at least one, two or more, or three or more of Equations 43 to 85. In detail, it may be seen that the optical system 1000 according to the embodiment satisfies all of Equations 1 to 85 above. Accordingly, the optical system 1000 may improve optical performance and optical characteristics at the center and the periphery portions of the FOV.

TABLE 3

| Equations | | Embodiment 1 | Embodiment 2 |
|---|---|---|---|
| 43 | 0 < F/\|L8R2\| < 5 | 0.748 | 0.728 |
| 44 | 1 < F/L1R1 < 10 | 2.615 | 2.646 |
| 45 | 0 < EPD/\|L8R2\| < 5 | 0.377 | 0.099 |
| 46 | 0.5 < EPD/L1R1 < 8 | 1.319 | 1.339 |
| 47 | −5 < F1/F2 < 0 | −0.350 | −0.439 |
| 48 | 1 < F12/F < 5 | 1.450 | 1.500 |
| 49 | 0 < \|F48/F13\| < 2 | 0.643 | 0.643 |
| 50 | 0 < F1/F < 3 | 1.038 | 0.954 |
| 51 | 0 < F1/F13 < 2 | 1.035 | 0.953 |
| 52 | 0 < F1/\|F48\| < 2 | 1.609 | 1.482 |
| 53 | 0 < \|F1/F4\| < 1 | 0.110 | 0.061 |
| 54 | 2 < TTL < 20 | 7.930 | 7.930 |
| 55 | 2 < ImgH | 7.935 | 7.935 |
| 56 | BFL < 2.5 | 1.016 | 1.034 |
| 57 | 2 < F < 20 | 7.573 | 7.588 |
| 58 | FOV < 120 | 90.0 | 90.0 |
| 59 | 0.1 < TTL/CA_max < 2 | 0.686 | 0.688 |
| 60 | 0.5 < TTL/ImgH < 3 | 0.999 | 0.999 |
| 61 | 0 < BFL/ImgH < 0.5 | 0.128 | 0.130 |
| 62 | 4 < TTL/BFL < 10 | 7.809 | 7.666 |
| 63 | 0.5 < F/TTL < 1.5 | 0.955 | 0.957 |
| 64 | 3 < F/BFL < 10 | 7.457 | 7.335 |
| 65 | 0 < F/ImgH < 3 | 0.954 | 0.956 |
| 66 | 1 < F/EPD < 5 | 1.982 | 1.976 |
| 67 | 0 < BFL/TD < 0.3 | 0.147 | 0.150 |
| 68 | 0 < EPD/ImgH/FOV < 0.2 | 0.005 | 0.005 |
| 69 | 10 < FOV/F# < 55 | 45.401 | 45.545 |
| 70 | 0 < n1/n2 < 1.5 | 0.916 | 0.905 |
| 71 | 0 < n3/n4 < 1.5 | 0.918 | 0.918 |
| 72 | 0.5 < Inf71/Inf72 < 2 | 0.800 | 0.800 |
| 73 | 0.5 < Inf71/Inf82 < 1.5 | 1.231 | 1.231 |
| 74 | 1 < Inf72/Inf82 < 5 | 1.538 | 1.538 |
| 75 | 5 < (TTL/ImgH)*n < 15 | 7.995 | 7.995 |
| 76 | 4 < (F/ImgH)*n < 14 | 7.635 | 7.650 |
| 77 | 10 < (TD_LG2/TD_LG1)*n < 35 | 16.630 | 16.896 |
| 78 | 10 < (CT_Max + CG_Max)*n < | 13.504 | 13.612 |
| | 20 | | |
| 79 | 50 < (FOV*TTL)/n < 120 | 89.212 | 89.212 |
| 80 | (TTL*n) > FOV | Satisfaction | Satisfaction |
| 81 | (v2*n2) < (v1*n1) | Satisfaction | Satisfaction |
| 82 | 0 ≤ \|Fx − Fy\| ≤ 0.1 | Satisfaction | Satisfaction |
| 83 | F7x ≠ F7y | Satisfaction | Satisfaction |
| 84 | F8x ≠ F8y | Satisfaction | Satisfaction |
| 85 | Fx/Fy < F7x/F7y | Satisfaction | Satisfaction |

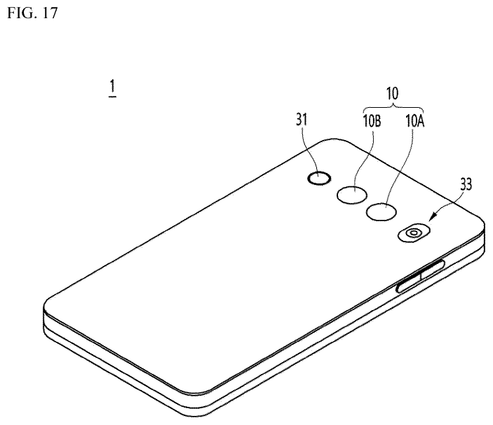

FIG. 17 is a diagram illustrating that a camera module according to an embodiment is applied to a mobile terminal. Referring to FIG. 17, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy. In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention. In addition, although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And differences related to these modifications and applications should be construed as being included in the scope of the invention as defined in the appended claims.

1.-23. (canceled)

24. An optical system comprising:
first to eighth lenses aligned along an optical axis from an object side toward a sensor side,
wherein an object-side surface of the first lens is convex,
wherein at least one of an object-side and sensor-side surfaces of the seventh lens has at least one critical point,
wherein at least one of an object-side and sensor-side surfaces of the eighth lens has a freeform surface shape in which lens surfaces in a first direction and a second direction orthogonal to each other with respect to the optical axis are asymmetric,
wherein the freeform surface has both lens surfaces having a symmetrical shape in the first direction with respect to the optical axis, and both lens surfaces having a symmetrical shape in the first direction in the second direction with respect to the optical axis, and
wherein the seventh and eighth lenses have a convex meniscus shape toward the sensor side.

25. The optical system of claim 24, wherein each of the object-side surface and the sensor-side surface of the seventh lens has the critical point, and
wherein the critical point of the sensor-side surface of the seventh lens is disposed further outside than the critical point of the object-side surface with respect to the optical axis.

26. The optical system of claim 24, wherein the object-side surface of the eighth lens is provided without a critical point from the optical axis to an end of an effective region.

27. The optical system of claim 25, wherein the sensor-side surface of the eighth lens has a critical point, and the critical point of the sensor-side surface of the eighth lens is located closer to the optical axis than the critical point of the seventh lens, and
wherein the critical point of the sensor-side surface of the eighth lens is located at different distances from each other along the first direction and the second direction orthogonal to each other with respect to the optical axis.

28. The optical system of claim 24, wherein at least one of the seventh lens and the eighth lens includes regions having different thicknesses at the same distance along the first and second directions orthogonal to each other with respect to the optical axis.

29. The optical system of claim 24, wherein a distance between the sixth lens and the seventh lens includes regions having different distances at the same distance along the first direction and the second direction orthogonal to each other with respect to the optical axis.

30. The optical system of claim 24, wherein a distance between the seventh lens and the eighth lens includes regions having different distances at the same distance along the first direction and the second direction orthogonal to each other with respect to the optical axis.

31. The optical system of claim 24, wherein a maximum angle between the optical axis and a normal line perpendicular to a tangent passing through the sensor-side surface of the seventh lens or the eighth lens includes regions having different angles at the same distance along the second direction and the first direction orthogonal with respect to the optical axis.

32. The optical system of claim 24, wherein the first lens has positive refractive power and has a meniscus shape convex toward the object side on the optical axis, and
wherein the second and third lenses have refractive powers opposite to each other, and each of the second and third lenses has a meniscus shape convex toward the object side on the optical axis.

33. The optical system of claim 24, wherein an object-side and sensor-side surfaces of the fourth lens have a concave shape on the optical axis,
wherein the fourth and fifth lenses have refractive powers opposite to each other, and
wherein the seventh and eighth lenses have refractive powers opposite to each other.

34. An optical system comprising:
a first lens portion disposed along an optical axis from an object side to a sensor side and having a plurality of lenses having rotationally symmetrical aspheric surfaces; and
a second lens portion disposed on the sensor side of the first lens portion and including a plurality of lenses having non-rotationally symmetric curved surfaces,
wherein each of the lenses of the second lens portion has a non-rotationally symmetrical thickness along first and second directions orthogonal to the optical axis,
wherein a distance between the lenses of the second lens portion is non-rotationally symmetrical along the first and second directions orthogonal to each other with the optical axis, and
wherein lenses having the non-rotationally symmetrical surfaces have a convex meniscus shape toward the sensor side.

35. The optical system of claim 34, wherein an effective focal length of the optical system in the first direction is Fx,
wherein an effective focal length in the second direction is Fy, and
wherein the following Equation satisfies: 0≤|Fx−Fy|≤0.1.

36. The optical system of claim 34, wherein each of the lenses of the second lens portion has different effective focal lengths in the first direction and in the second direction.

37. The optical system of claim 34, wherein at least three of the lenses of the first lens portion disposed close to the object have a convex meniscus shape toward the object side, wherein an object-side surface and a sensor-side surface of each of the lenses of the second lens portion have freeform surfaces.

38. The optical system of claim 34, wherein a distance from a center of the object side of the first lens portion to an image surface of the image sensor is TTL,
wherein ½ of a diagonal length of the image sensor is ImgH,
wherein a total number of the lenses is n, and
wherein the following Equation satisfies: 5< (TTL/ImgH)*n<15.

39. The optical system of claim 34, wherein an effective focal length of the optical system is F,
wherein ½ of a diagonal length of an image sensor is ImgH,
wherein a total number of the lenses is n, and
wherein the following Equation satisfies: 4< (F/ImgH)*n<14.

40. An optical system comprising:
a first lens group having lenses having a meniscus shape convex to an object side; and
a second lens group aligned on a sensor side of the first lens group,
wherein the second lens group is more lenses than a number of the lenses of the first lens group,
wherein the first lens group has a positive (+) refractive power on an optical axis,
wherein the second lens group has a negative (−) refractive power on the optical axis,
wherein the number of the lenses of the second lens group is less than twice the number of lenses of the first lens group,
wherein one of the lenses adjacent between the first and second lens groups has a minimum effective diameter,
wherein an n-th lens closest to an image sensor among the lenses of the second lens group has a largest effective diameter, and
wherein the n-th lens and an n−1th lens of the second lens group have a non-rotationally symmetric curved surface.

41. The optical system of claim 40, wherein a sensor-side surface of the n-th lens, an object-side surface and a sensor-side surface of the n−1th lens have a critical point,
wherein the non-rotationally symmetric curved surface has both lens surfaces having a symmetrical shape in a first direction orthogonal to the optical axis and has both lens surfaces having a symmetrical shape in a second direction orthogonal to the optical axis, and
wherein the lens surfaces in the first and second directions have asymmetrical shape to each other.

42. The optical system of claim 41, wherein the n-th lens and the n−1th lens include regions having different thicknesses at the same distance from the optical axis along the first and second directions orthogonal to the optical axis.

43. A camera module comprising:
an image sensor; and
a filter between the image sensor and a last lens of an optical system; and
wherein the optical system is an optical system according to claim 24,
wherein a distance from a center of a lens surface closest to an object to an image surface of the image sensor is TTL,
wherein ½ of a diagonal length of the image sensor is ImgH,
wherein a maximum of a center thicknesses of each lens is CT_Max,
wherein a maximum distance between adjacent lenses is CG_Max,
wherein a total number of lenses is n,
wherein the following Equation 1 satisfies: 5<(TTL/ImgH)*n<15, and
wherein the following Equation 2 satisfies: 10<(CT_Max+CG_Max)*n<20.
